(19) United States
(12) Patent Application Publication
(10) Pub. No.: US 2023/0324551 A1
(43) Pub. Date: Oct. 12, 2023

(54) ADAPTIVE SELF-CALIBRATING LIDAR SYSTEM

(71) Applicant: California Institute of Technology, Pasadena, CA (US)

(72) Inventors: Aroutin Khachaturian, Pasadena, CA (US); Parham Porsandeh Khial, Kirkland, WA (US); Seyed Ali Hajimiri, La Canada, CA (US)

(21) Appl. No.: 18/127,331

(22) Filed: Mar. 28, 2023

Related U.S. Application Data
(60) Provisional application No. 63/324,319, filed on Mar. 28, 2022.

(51) Int. Cl. G01S 17/58; G01S 7/481; G01S 7/4911; G06N 3/08

(52) U.S. Cl. CPC G01S 17/58; G01S 7/4815; G01S 7/4816; G01S 7/4911; G06N 3/08

(57) ABSTRACT

An adaptive LiDAR includes, in part, a transmitter and a receiver. The transmitter includes, in part, an array of N radiators, and a transmitter control block adapted to control an aperture of the transmitter. The receiver includes, in part, an array of T receive elements, and a receiver control block adapted to control a scan rate and resolution of the receiver. M and T are integers greater than one.

### RELATED APPLICATION

The present application claims benefit under 35 USC 119(e) of U.S. Patent Application No. 63/324,319, filed Mar. 28, 2022, the content of which is incorporated herein by reference in its entirety.

### TECHNICAL FIELD

The present application relates to electronic systems, and more particularly to adaptive light detection and ranging systems (LIDARs).

### BACKGROUND

Generating three-dimensional (3D) images using optical frequencies (such as visible light, near infrared, mid-infrared frequencies) is advantageous over Radio Frequency (RF) and millimeter-wave signals due to their smaller wavelengths. An image acquisition system using optical signals thus has a relatively smaller aperture size, system cost, and complexity.

Traditional 3D mapping technologies have relied on mechanical moving parts that enable the steering of the beam for point-by-point scanning. Integrated photonics platforms (such as silicon photonics) have enabled the realization of solid-state beam steering and beamforming. These systems have advantages over their mechanical counterparts, due in part, to their beam steering speed, lower cost, and relative immunity to mechanical vibrations and environmental variations.

### SUMMARY

An adaptive LiDAR, in accordance with one embodiment of the present disclosure, includes, in part, a transmitter and a receiver. The transmitter includes, in part, an array of N radiators, and a transmitter control block adapted to control an aperture of the transmitter. The receiver includes, in part, an array of T receive elements, and a receiver control block adapted to control a scan rate and resolution of the receiver. M and T are integers greater than one.

In one embodiment, the transmitter control block is adapted to control the aperture of the transmitter in accordance with data supplied by a user. In one embodiment, the receiver control block is adapted to control the scan rate and resolution of the receiver in accordance with data supplied by a user. In one embodiment, the receiver control block causes the receiver to discern a target at a first scan rate using a first resolution during a first time interval, and to discern the target at a second scan rate using a second resolution during a second time interval. The second scan rate is lower than the first scan rate, and the second resolution is higher than first resolution.

In one embodiment, the transmitter and receiver control blocks are adapted to cause each of M radiators of the transmitter to be associated with each of Q receive elements of the receiver. M is an integer equal to or greater than 1 and less than N, and Q is an integer equal to or greater than 1 and less than T. In one embodiment, the adaptive LiDAR further includes, in part, a first cylindrical lens positioned away from the array of radiator.

In one embodiment, the transmitter control block is adapted to cause a beam focused by the lens to move along a direction substantially perpendicular to a central axis of the lens by activating radiators disposed along different rows of the array of radiators. In one embodiment, the adaptive LiDAR further includes, in part, a second cylindrical lens positioned away from the array of receive elements.

In one embodiment, the adaptive LiDAR further includes, in part, a multitude of tunable amplitude modulators adapted to generate N optical signals from an incoming optical signal. Each tunable amplitude modulator includes, in part, a first signal splitter adapted to split a received optical signal into first and second optical signals; a phase modulator adapted to modulate a phase of the first signal in accordance with a phase control signal to generate a first phase modulated signal; a directional coupler adapted to combine the second optical signal with the first phase modulated signal to generate a first output signal and a first intermediate optical signal; a second splitter adapted to split the first intermediate optical signal into a second output signal and a second intermediate optical signal; a photodetector adapted to convert the second intermediate optical signal to an electrical signal; and a controller configured to generate the phased control signal using the electrical signal.

In one embodiment, the controller is further configured to generate the phase control signal via a control signal generated internally by the adaptive LiDAR. In one embodiment, the controller is further configured to generate the phase control signal via a control signal supplied by a user. In one embodiment, the relative powers of the first and second optical signal may be varied. In one embodiment, the relative powers of the second output signal and the second intermediate optical signal may be varied. In one embodiment, the power of the second output signal is substantially 99 times the power of the second intermediate optical signal.

The adaptive LiDAR, in accordance with one embodiment of the present disclosure further includes, in part, a multitude of phase and amplitude modulation blocks each including, in part, a first phase and amplitude modulator adapted to modulate a phase and/or an amplitude of a first one of the N output signals of the multitude of tunable amplitude modulators in accordance with a first control signal to generate a first modulated signal; a second phase and amplitude modulator adapted to modulate a phase and/or an amplitude of a second one of the N output signals of the multitude of tunable amplitude modulators in accordance with a second control signal to generate a second modulated signal; a third signal splitter adapted to split the first modulated signal into a first output signal and a first and second intermediate signals; a fourth signal splitter adapted to split the second modulated signal into a second output signal and a third and fourth intermediate signals; a phase detector adapted to detect a difference between phases of the first and third intermediate signals; a first amplitude detector adapted to detect an amplitude of the second intermediate; a second amplitude detector adapted to detect an amplitude of the fourth intermediate signal; and a controller adapted to generate the first and second control signals in accordance with the detected difference between phases of the first and third intermediate signals, and the detected amplitudes of the second and fourth intermediate signals.

In one embodiment, the multitude of phase and amplitude modulation blocks generate N optical signals each received by a different one of the array of N radiators. In one embodiment, the adaptive LiDAR further includes, in part, (N−1) optical switching layers adapted to generate N optical signals each received by a different one of the array of N radiators. The j^{th} optical switching layer includes 2j optical switches, wherein j is in index ranging from 1 to (N−1). Each optical switch is adapted to split a received optical signal into a pair of optical signals.

In one embodiment, the N optical signals generated by the (N−1) optical switching layers is delivered as N reference signals to the receiver. In one embodiment, the speed of a switch disposed in a first layer of the (N−1) optical switching layers is slower than a speed of a switch disposed in layer (N−1) of the optical switching layers. In one embodiment, each receive element includes, in part, a gating coupler and a photodiode.

In one embodiment, the adaptive LiDAR further includes, in part, a first laser source. In one embodiment, the adaptive LiDAR further includes, in part, a multitude of semiconductor optical amplifiers each adapted to amplify a laser beam generated by the first laser source, and deliver the amplified laser beam to a different one of the multitude of tunable amplitude modulators. In one embodiment, the adaptive LiDAR further includes, in part, a path/phase mismatch correction block adapted to cause phases of the beams received from the multitude of phase and amplitude modulators to have a same value.

In one embodiment, the adaptive LiDAR further includes, in part, a second laser source having a wavelength that is different from a wavelength of the first laser source; a first multitude of semiconductor optical amplifiers each adapted to amplify a laser beam generated by the first laser source and deliver the amplified laser beam to a different one of a first subset of the multitude of tunable amplitude modulators; and a second multitude of semiconductor optical amplifiers each adapted to amplify a laser beam generated by the second laser source and deliver the amplified laser beam to a different one of a second subset of the multitude of tunable amplitude modulators.

In one embodiment, the transmitter control block is adapted to cause formation of an optical beam that is steered in accordance with phases of a multitude of optical signals received by the multitude of radiators. In one embodiment, the receive control block is further adapted to change a direction of the receive elements.

In one embodiment, the adaptive LiDAR further includes, in part, a first cylindrical lens positioned away from the array of radiators; and a second cylindrical lens positioned away from the array of receive elements. In one embodiment, the adaptive LiDAR further includes, in part, a first laser source; and a second laser source having a different wavelength than the first laser source.

In one embodiment, the adaptive LiDAR further includes, in part, a multitude of semiconductor optical amplifiers each adapted to amplify a laser beam generated by the first laser source to generate an amplified laser beam; a path/phase mismatch correction block adapted to cause phases of the multitude of amplified laser beams to have the same value; and an optical combiner adapted to combine the multitude of amplified laser beams and deliver the combined beam to the multitude of radiators.

In one embodiment, the adaptive LiDAR further includes, in part, a multitude of semiconductor optical amplifiers each adapted to amplify a laser beam generated by the first laser source to generate a first multitude of amplified beams; a first multitude of optical switching layers receiving the first multitude of amplified beams to generate first a multitude of optical signals; a second multitude of semiconductor optical amplifiers each adapted to amplify a laser beam generated by the second laser source to generate a second multitude of amplified beams; a second multitude of optical switching layers receiving the second multitude of amplified beams to generate a second multitude of optical signals; a first path/phase mismatch correction block adapted to shift phases of the first multitude of optical signals so that the first multitude of phase shifted optical signals have the same phase, wherein the first path/phase mismatch correction block delivers the first multitude of phase shifted optical signals to a first subset of the N radiators; and a second path/phase mismatch correction block adapted to shift phases of the second multitude of optical signals so that the second multitude of phase shifted optical signals have the same phase. The second path/phase mismatch correction block delivers the second multitude of phase shifted optical signals to a second subset of the N radiators.

In one embodiment, each of the arrays of radiators and receive elements is a two-dimensional array. In one embodiment, the adaptive LiDAR further includes, in part, a first array of N micro-lenses positioned over the N radiators, wherein each of the N micro-lenses of the first array is associated with a different one of the N radiators; and a second array of T micro-lenses positioned over the T receive elements, wherein each of the T micro-lenses of the second array is associated with a different one of the T receive elements.

In one embodiment, the adaptive LiDAR further includes, in part, a first array of P micro-lenses positioned over the N radiators, wherein N is an integer multiple of P, and wherein each of the P micro-lenses of the first array is associated with and receives light from N/P radiators. The adaptive LiDAR further includes, in part, a second array of S micro-lenses positioned over the T receive elements, wherein T is an integer multiple of S, and wherein each of the S micro-lenses of the second array is associated with and delivers light to T/S receive elements.

In one embodiment, the transmitter and receiver control block cause a spot size illuminated by transmitter to be greater than a maximum resolution of the receiver. In one embodiment, the transmitter and receiver control blocks cause a spot size illuminated by transmitter to be greater than a maximum resolution of the receiver. In one embodiment, the transmitter and receiver control blocks are adapted to cause each of M radiators of the transmitter to be associated with each of Q receive elements of the receiver, wherein M is an integer equal to or greater than 1 and less than N, and wherein Q is an integer equal to or greater than 1 and less than T.

In one embodiment, the transmitter and receiver control blocks are adapted to cause each of M radiators of the transmitter to be associated with each of Q receive elements of the receiver, wherein M is an integer equal to or greater than 1 and less than N, and wherein Q is an integer equal to or greater than 1 and less than T.

An adaptive LiDAR, in accordance with one embodiment of the present disclosure, includes, in part, a transmitter, a receiver, an encoder, first and second modulators, a signal combiner, and a first controller. The transmitter includes, in part, an array of N radiators. The receiver includes, in part, an array of T receive elements. The encoder is adapted to generate a first and second encoding signals. The first modulator is adapted to modulate a first portion of a laser beam using the first encoding signal, thereby to generate a reference optical signal. The second modulator is adapted to modulate a second portion of the laser beam using the second encoding signal, thereby to generate an optical signal applied to the transmitter, wherein the transmitter illuminates a moving target using the optical signal, wherein the receiver receives an optical signal reflected off the illuminated moving target. The signal combiner is adapted to combine the reference optical signal with the received optical signal to generate a combined signal. The signal combiner is further adapted to convert the combined signal to an electrical signal. The first controller is adapted to vary the first and second encoding signals in accordance with the electrical signal.

In one embodiment, the adaptive LiDAR further includes, in part, an amplifier adapted to amplify the electrical signal; and a downconverter adapted to downconvert a frequency of the amplified signal. In one embodiment, the adaptive LiDAR further includes, in part, a filter adapted to filter noise components of the downconverted signal; and a digital-to-analog converter adapted to convert an output of the downconverter to a digital signal and supply the digital signal to the first controller. The first controller is adapted to vary the first and second encoding signals in accordance with the digital signal.

In one embodiment, the adaptive LiDAR further includes, in part, a second controller adapted to vary a gain of the amplifier. In one embodiment, the second controller is adapted to vary the downconversion frequency of the downconverter. In one embodiment, the second controller is adapted to change the frequency band of the filter.

In one embodiment, the first controller is adapted to cause frequencies of the reference optical signal and the received optical signal to ramp at a first rate during a first time interval, and at a second rate during a second time interval. In one embodiment, the first controller is adapted to cause frequencies of the reference optical signal and the received optical signal to ramp at a first rate during a first time interval, and further to cause amplitudes of the reference optical signal and the received optical signal to ramp at a second rate during the first time interval. In one embodiment, the first controller is adapted to cause frequencies of the reference optical signal and the received optical signal to ramp at a third rate during a second time interval, and further to cause amplitudes of the reference optical signal and the received optical signal to ramp at a fourth rate during the second time interval.

A method of determining a distance and a speed of a moving target using an adaptive LiDAR, in accordance with one embodiment of the present disclosure, includes, in part, illuminating the target by a transmitter of the adaptive LiDAR. The transmitter includes, in part, an array of N radiators; and a transmitter control block adapted to control an aperture of the transmitter. The method further includes, in part, receiving an optical signal reflected off the illuminated target, wherein the received optical signal is received by a receiver of the adaptive LiDAR. The receiver includes, in part, an array of T receive elements; and a receiver control block adapted to control a scan rate and resolution of the receiver, wherein M and T are integers greater than one, The method further includes, in part, determining the distance and the speed of the moving target in accordance with the received optical signal.

In one embodiment, the method further includes, in part, acquiring an image of the target by a CMOS/CCD camera. In one embodiment, the method further includes, in part, transmitting a radio frequency (RF) RADAR signal to the moving target; and receiving an RF signal reflected off the moving target.

In one embodiment, the method further includes, in part, training a machine learning system to operate the adaptive LiDAR. In one embodiment, the method further includes, in part, positioning a first cylindrical lens away from the array of radiators. In one embodiment, the method further includes, in part, generating N optical signals via (N−1) optical switching layers, Each optical signal is received by a different one of the array of N radiators, wherein a j^{th} optical switching layer includes 2j optical switches, wherein j is in index ranging from 1 to (N−1), Each optical switch is adapted to split a received optical signal into a pair of optical signals. The speed of a switch disposed in a first layer of the (N−1) optical switching layers is slower than a speed of a switch disposed in layer (N−1) of the (N−1) optical switching layers.

In one embodiment, the method further includes, in part, amplifying a laser beam by a multitude of semiconductor optical amplifiers; delivering the amplified laser beams to a multitude of tunable amplitude modulators; and causing phases of the laser beams received from the multitude of phase and amplitude modulators to have the same value.

In one embodiment, the adaptive LiDAR further includes, in part, a first array of N micro-lenses positioned over the N radiators, and a second array of T micro-lenses positioned over the T receive elements. Each of the N micro-lenses of the first array is associated with a different one of the N radiators. Each of the T micro-lenses of the second array is associated with a different one of the T receive elements.

A method of determining a distance and a speed of a moving target using an adaptive LiDAR, in accordance with one embodiment of the present disclosure, includes, in part, generating first and second encoding signals; modulating a first portion of a laser beam using the first encoding signal, thereby to generate a reference optical signal; modulating a second portion of the laser beam using the second encoding signal, thereby to generate a transmit optical signal; illuminating the target by a transmitter of the adaptive LiDAR using the transmit optical signal; receiving an optical signal reflected off the illuminated target, wherein the received optical signal is received by a receiver of the adaptive LiDAR, wherein the receiver comprises an array of T receive elements; combining the reference optical signal with the received optical signal to generate a combined signal; converting the combined signal to an electrical signal; and varying the first and second encoding signals in accordance with the electrical signal. The transmitter includes, in part, an array of N radiators. The receiver includes, in part, an array of T receive elements, wherein N and T are integers greater than one.

A machine learning system, in accordance with one embodiment of the present disclosure, includes, in part, a computing system; a trained neural network; and an adaptive LiDAR. The adaptive LiDAR includes, in part, a transmitter and a receiver. The transmitter includes, in part, an array of N radiators, and a transmitter control block adapted to control an aperture of the transmitter. The receiver includes, in part, an array of T receive elements, and a receiver control block adapted to control a scan rate and resolution of the receiver. M and T are integers greater than one.

A material detection system in accordance with one embodiment of the present disclosure, includes, in part, a computing system; a trained neural network; and an adaptive LiDAR. The adaptive LiDAR includes, in part, a transmitter and a receiver. The transmitter includes, in part, an array of N radiators, and a transmitter control block adapted to control an aperture of the transmitter. The receiver includes, in part, an array of T receive elements, and a receiver control block adapted to control a scan rate and resolution of the receiver. M and T are integers greater than one.

### BRIEF DESCRIPTION OF THE DRAWINGS

FIG. 1 is a simplified high-level block diagram of a self-calibrating, self-correcting adaptive LiDAR, in accordance with one embodiment of the present disclosure.

FIG. 2 is a simplified view of an optical phased array, in accordance with one embodiment of the present disclosure.

FIG. 3 is a simplified high-level block diagram of a tunable amplitude modulator, in accordance with one embodiment of the present disclosure.

FIG. 4A is a block diagram of the tunable amplitude modulator shown in FIG. 3, in accordance with one embodiment of the present disclosure.

FIG. 4B is a block diagram of a tunable amplitude modulator, in accordance with another embodiment of the present disclosure.

FIG. 4C is a block diagram of a tunable amplitude modulator, in accordance with another embodiment of the present disclosure.

FIG. 5 is a schematic diagram of a two-channel amplitude and phase calibration system, in accordance with one embodiment of the present disclosure.

FIG. 6 is a block diagram of a configurable amplitude and phase modulator, in accordance with one embodiment of the present disclosure.

FIG. 7 shows the configurable amplitude and phase modulator of FIG. 6 supplying its N optical output signals to an N-element optical transmitter and receiver array, in accordance with one embodiment of the present disclosure.

FIGS. 8A, 8B, and 8C show a focal plane array having disposed therein a lens used to focus the beam radiated by the focal plane array of radiators on to a target, in accordance with one embodiment of the present disclosure.

FIG. 9A is a simplified view of a focal plane array, in accordance with one embodiment of the present disclosure.

FIG. 9B is a simplified view of a focal plane array, in accordance with another embodiment of the present disclosure.

FIG. 10 show a hybrid optical phased array transmitter which includes, in part, a two-dimensional array of radiators positioned in front of a cylindrical lens, in accordance with another embodiment of the present disclosure.

FIG. 11A is a simplified high-level block diagram of an optical phased array receiver, in accordance with one embodiment of the present disclosure.

FIG. 11B is a simplified high-level block diagram of a focal plane array receiver, in accordance with one embodiment of the present disclosure.

FIG. 12A shows an exemplary transmitted beam when only a part of the transmitter array is activated, in accordance with one embodiment of the present disclosure.

FIG. 12B shows a receiver aperture size selected to discern spot size illuminated by the transmitted beam of FIG. 12A.

FIG. 13A shows an exemplary transmitted beam when an entire transmitter array is activated, in accordance with one embodiment of the present disclosure.

FIG. 13B shows a receiver aperture size selected to discern a spot size that is larger than the beam of FIG. 13A, in accordance with one embodiment of the present disclosure.

FIG. 14A shows an array of transmitters of a LiDAR adapted to include a micro-lens array, in accordance with one embodiment of the present disclosure.

FIG. 14B shows an array of receive elements of a LiDAR adapted to include a micro-lens array, in accordance with one embodiment of the present disclosure.

FIG. 14C shows an array of transmitters of a LiDAR adapted to include a micro-lens array, in accordance with another embodiment of the present disclosure.

FIG. 15A shows an array of M×N spot sizes that may be illuminated along the two-dimensional array by a transmitter adapted to include a micro lens array.

FIG. 15B shows an array of of M×N spot sizes that may be discerned by a receiver adapted to include a micro lens array.

FIG. 16A shows an example of a far-field radiation pattern of an adaptive transceiver at a relatively high resolution and a relatively low refresh rate, in accordance with one embodiment of the present disclosure.

FIG. 16B shows a far-field radiation pattern of the adaptive transceiver of FIG. 16A, when the transmitter of the transceiver is selected to operate at an intermediate resolution and an intermediate refresh rate.

FIG. 16C shows a far-field radiation pattern of the adaptive transceiver of FIG. 16A, when the transmitter of the transceiver is selected to operate at a relatively low resolution and a relatively high refresh rate.

FIG. 17A is a block diagram of an adaptive LiDAR transmitter, in accordance with one embodiment of the present disclosure.

FIG. 17B is a block diagram of an adaptive LiDAR transmitter, in accordance with another embodiment of the present disclosure.

FIG. 17C is a block diagram of a multi-modal adaptive LiDAR, in accordance with one embodiment of the present disclosure.

FIG. 18A shows the linear ramp in frequency of a reference LO signal as well as the optical signal received from a target, in accordance with one embodiment of the present disclosure.

FIG. 18A shows the linear ramp in frequency of a reference LO signal as well as the optical signal received from a target, in accordance with one embodiment of the present disclosure.

FIG. 18C shows a linear ramp in frequency of a first chirp FMCW signal used to modulate the amplitudes of a reference signal as well as the light signal received from a target, in accordance with one embodiment of the present disclosure.

FIG. 18D shows a linear ramp in frequency of a second chirp FMCW signal used to modulate the phases of the reference signal as well as the light signal received from a target, in accordance with another embodiment of the present disclosure.

FIG. 19 is a block diagram of a number of components disposed in an adaptive LiDAR 1900 adapted perform time-domain encoding, in accordance with one embodiment of the present disclosure.

FIG. 20 is a simplified view of an autonomous imaging system includes an adaptive LiDAR, in accordance with one embodiment of the present disclosure.

FIG. 21 is a simplified view of a material detection system that includes an adaptive LiDAR, in accordance with one embodiment of the present disclosure.

### DETAILED DESCRIPTION

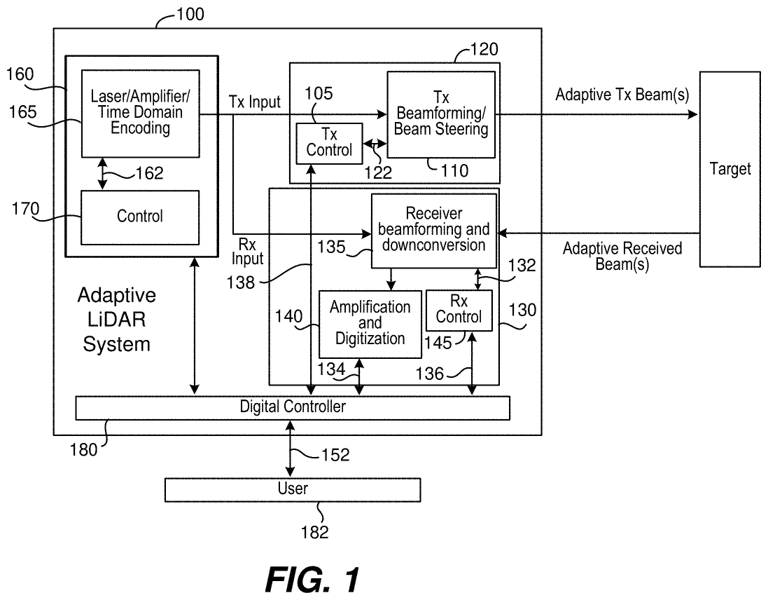

FIG. 1 is a simplified high-level block diagram of a self-calibrating, self-correcting adaptive LiDAR 100 (hereinafter alternatively referred to as adaptive LiDAR), in accordance with one embodiment of the present disclosure. Adaptive LiDAR 100 is shown, as including, in part, an adaptive beam transmitter 120, an adaptive beam receiver 130, an adaptive coherent signal generation and encoding block 160, and a digital controller 180.

Adaptive beam transmitter 120 is shown as including, in part, a transmit (also referred to herein as Tx) control block 105 and a transmit beamforming and beam steering block 110. Double-headed arrow 122 indicates the two-way flow of control and data signals between Tx control block 105 and transmit beamforming and beam steering block 110 used for internal beam calibration and stabilization.

Adaptive beam receiver 130 is shown as including, in part, a receiver (also referred to herein as receive or Rx) control block 145, a receiver beamforming and down-conversion block 135, and an amplification and digitization block 140. Double-headed arrow 132 indicates the two-way flow of control and data signals between Rx control block 145 and receive beamforming and down conversion block 135 used for internal beam calibration and stabilization. Double-headed arrow 134 indicates the two-way flow of control and data signals between amplification and digitization block 140 and digital controller 180 used for adaptive signal acquisition and digitization either by user 182, or by digital controller 180 during a self-calibrating or self-control mode.

Adaptive coherent signal generation and encoding block 160 is shown as including, in part, a laser amplification and time domain encoding block 165, and laser/encoding control block 170. Double-headed arrow 162 indicates the two-way flow of control and data signals between laser amplification/time domain encoding block 165 and laser/encoding control block 170 used for internal stabilization and self-calibration. Double-headed arrow 152 indicates the two-way flow of control and data signals between digital controller 180 and a user 182 of LiDAR 100 for adaptive system adjustment based on user requirements. Double-headed arrow 136 indicates the two-way flow of control and data signals between digital controller 180 and RX control block 145 for enhanced adaptivity of LiDAR 100 either by user 182, or through various control blocks disposed in LiDAR 100. Similarly, double-headed arrow 138 indicates the two-way flow of control and data signals between digital controller 180 and TX control block 105 for enhanced adaptivity of LiDAR 100 either by user 182, or through various control blocks disposed in LiDAR 100.

Adaptive LiDAR 100 may be used together with other imaging and sensing systems such as a Radio Frequency (RF) RADAR, sonar imager, or a standard CMOS/CCD camera to generate a multi-modal imaging system capable of further enhancing target detection and identification.

Adaptive LiDAR 100 may also be used in spectroscopy in which the returned optical signal may be processed to quantify the properties of the materials in the target being imaged. Adaptive Li DAR 100 may further be used in microscopy, medical imaging, medical diagnostics, and the like. The return optical signal may be processed using various signal processing techniques such as Kalman filters, machine learning such as artificial neural networks, deep learning, and the like, to enhance the quality of the imaged target.

As is described in detail below, adaptive LiDAR 100 can self-configure and adapt to various imaging conditions as well as user requirements. The transmitter beamforming and beam steering, the receiver beamforming, the frequency of operation, the time-domain encoding, and the processing of the received optical signals may be re-configured and varied in real-time to meet the desired performance. Adaptive LiDAR 100, therefore, does not suffer from such conditions as high signal attenuation from distant targets and interference and noise from various optical and electrical sources.

Adaptive beam transmitter 120 may be formed using an optical phased array (OPA) transmitter, a focal plane array (FPA) transmitter, or a hybrid of OPA and FPA transmitters. Adaptive beam receiver 130 may be formed using an OPA receiver, a FPA receiver, or a hybrid of OPA and FPA receivers, described further below.

The unit cell (also referred to herein as the receiver pixel or receive element) of the receiver may include, for example a photo-diode, or a photo-diode and a mixer, and the like. The unit cell of the receiver may be a direct detection receiver, or a heterodyne/homodyne receiver. The unit receiver cell may be a multi-phase receiver, such as those used in the IQ coherent receivers, to suppress the undesired carrier frequency fluctuations when determining the phase of the received signal.

In addition, the apertures of the adaptive beam transmitter and the adaptive beam receiver may be configured on the fly to enable multiplexing and demultiplexing, in order to enhance system performance. For example, the transmitter and receiver may be configured so that one transmitter pixel is associated with one receiver pixel; or multiple transmitter pixels are associated with one receiver pixel; or multiple receiver pixels are associated with one transmitter pixel. Such multiplexing and demultiplexing and the degree of association between the transmitter and receiver pixels may be used to increase the system performance, and reduce the system cost and complexity.

A number of different techniques may be used for coherent light (e.g., laser) generation, amplification and time-domain encoding. The coherent light generation, amplification and time-domain encoding is adaptive and may be changed between different modes of operation depending on the application.

### Transmitter Sub-System

As described above, an adaptive beam transmitter, in accordance with embodiments of the present disclosure, may include an optical phased array (OPA) transmitter, a focal plane array (FPA) transmitter, or a hybrid of OPA and FPA transmitter.

### Optical Phased Array (OPA)

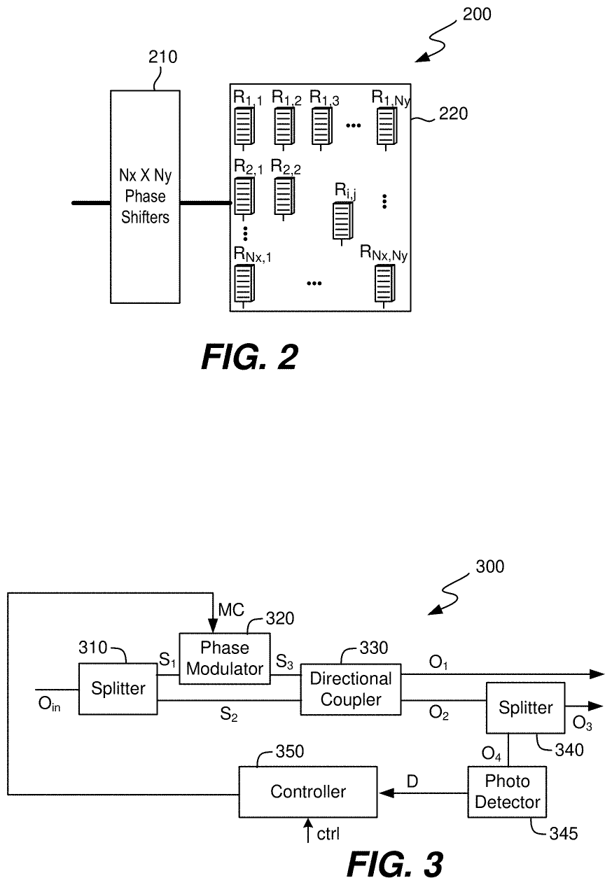

FIG. 2 is a simplified view of an OPA 200, in accordance with one embodiment of the present disclosure. OPA 200, which corresponds to transmit beam forming and beam steering 110 of FIG. 1, is shown as including Nx×Ny optical radiators forming aperture 220, as well as Nx×Ny phase shifters each associated and adapted to change a phase of a different one of the radiators. The radiators are disposed along Nx rows, and Ny columns. For example, row 1 of the aperture is shown as including radiators R₁₁, R₁₂ . . . R_{1Ny}; similarly row Nx is shown as including radiators R_{Nx1}, R_{Nx2} . . . R_{N_xN_y}. It is understood that OPA 200 also includes amplitude modulators and other components that are not shown in FIG. 2 for simplicity. OPA 200 generates a beam that can be steered for spot-by-spot illumination in accordance with the phases and/or amplitudes of the optical signals radiated by the radiators. In one example, all radiators receive equal power.

The diameter of the beam generated by OPA 200 is determined by the size of the aperture 220. The smaller the aperture size, the narrower is the beam. The aperture size is controlled by the number, and/or positions, of the radiators that are turned on. For example, by turning off, e.g., half the radiators Rᵢⱼ, where i is an index ranging from 1 to N and j is an index ranging from 1 to Ny in the example shown in FIG. 2, the width of the beam generated by OPA 200 become larger. Therefore, as described further below, embodiments of the present disclosure provide a selection between the beamwidth—and hence the resolution—of the OPA and the scan rate of the OPA. A user, or the LiDAR itself, may thus select to tune the OPA so as to operate the OPA at a relatively faster scan rate but at a relatively lower resolution. Alternatively, the user, or the LiDAR, may select to tune the OPA so as to operate the OPA at a relatively higher resolution but at a relatively slower scan rate.

The above-described tunability of the OPA may be achieved using a multitude of switches disposed along the path of the radiators, or using one or more tunable splitter tree adapted to redirect the transmitter power for different beam performances. For example, the power can be distributed uniformly from all the radiators to only a quarter of the radiators to reduce the resolution for a faster scan.

FIG. 3 is a simplified high-level block diagram of a tunable amplitude modulator 300, in accordance with one embodiment of the present disclosure. As described further below, tunable amplitude modulator 300 is adapted to receive an incoming optical signal Oᵢₙ, and generate a pair of output signals O₁ and O₃ whose relative power ratio is set to a desired value using control signal Ctrl.

Signal splitter 310, which may be a 50/50 optical splitter, splits the incoming optical signal Oᵢₙ into optical signals S₁ and S₂. Phase modulator (shifter) 320 modulates the phase of S₁ via the electrical phase control signal MC received from controller 350 to generate signal S₃. Directional coupler 330, which may be a 50/50 directional coupler, combines signals S₁ and S₃ to generate signals O₁ and O₂.

Signal splitter 310, phase modulator 320 and directional coupler form an interferometer. By varying signal MC the ratio of the power of signals O₁ and O₂ may be changed to a desired value. Splitter 340 splits signal O₂ into signals O₃ and O₄. Signals O₂ and O₃ are supplied as output signals of tunable amplitude modulator 300. Signal O₄ is converted by photo-detector 345 to electrical signal D. In response to signal D and control signal Ctrl, controller 150 generates the phase control signal MC. Therefore, by changing signal Ctrl, a user may set the ratio of the power of signals O₁ and O₂ to a desired through signal MC.

Splitter 340 generates signals O₃ and O₄ in accordance with any desired power ratio. For example, signals O₃ and O₄ may respectively represent 99% and 1% of signal O₂. In another example, signals O₃ and O₄ may respectively represent 98% and 2% of signal O₂. The feedback signal MC, among other advantages, enhances the transmitter beam quality, corrects fabrication imperfections, beam patterns variations due to laser frequency drift, and beam patterns variations due to temperature fluctuations.

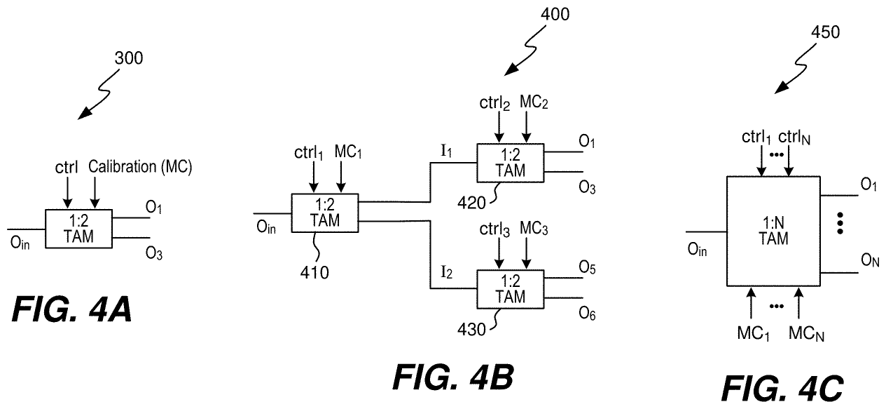

FIG. 4A is a block diagram of tunable amplitude modulator 300 shown in FIG. 3. As was described with reference to FIG. 3, tunable amplitude modulator 300 receives input signal Oᵢₙ, and generates output signals O₁ and O₃ in accordance with any desired power ratio using control signal Ctrl. In FIG. 4A, the phase control signal MC is shown as an output signal of tunable optical modulator 300.

FIG. 4B is a block diagram of a tunable amplitude modulator 400 adapted to receive a coherent optical signal Oᵢₙ and generate output signals O₁, O3, O5 and O₆, in accordance with another embodiment of the present disclosure. Tunable amplitude modulator 400 is shown as including tunable amplitude modulators 410, 420 and 430 each of which corresponds to the tunable amplitude modulator 300 shown in FIGS. 3 and 4A.

Tunable amplitude modulator 410 receives signal Oᵢₙ and generates signals I₁ and I₂ whose power ratio is determined in accordance with signal Ctrl₁. Tunable amplitude modulator 420 receives signal I₁ and generates signals O₁ and O₂ whose power ratio is determined in accordance with signal Ctrl₂. Tunable amplitude modulator 430 receives signal I₂ and generates signals O₅ and O₆ whose power ratio is determined in accordance with signal Ctr₃. Also shown in FIG. 4B are feedback phase control/calibration signals MC₁, MC₂ and MC₃ associated with tunable amplitude modulators 410, 420 and 430, respectively.

A tunable amplitude modulator, in accordance with embodiments of the present disclosure, may generate any number of output signals—whose relative powers may be adjusted—by cascading as many stages of tunable amplitude modulators 300 as desired. For example, in FIG. 4B, the cascading results in generation of four output signals.

FIG. 4C is a block diagram of a tunable amplitude modulator 450 that receives input signal Oᵢₙ and, in response, generates N output signals O₁ . . . O_{N}—whose relative powers may be adjusted—by cascading (N−1) stages of tunable amplitude modulators 300. The relative powers of signal O₁ . . . O_{N} may be adjusted using N control signal Ctrl₁ . . . Ctrl_{N}. For example, if the power of the input signal Oᵢₙ is P, and all the power is channeled to output O₁, the power of the output O₁ is P and the power of the remaining outputs O₂ . . . O_{N} is zero. Also shown in FIG. 4C are the N feedback signals MC₁ . . . MC_{N} each of which corresponds to signal MC shown in FIG. 3.

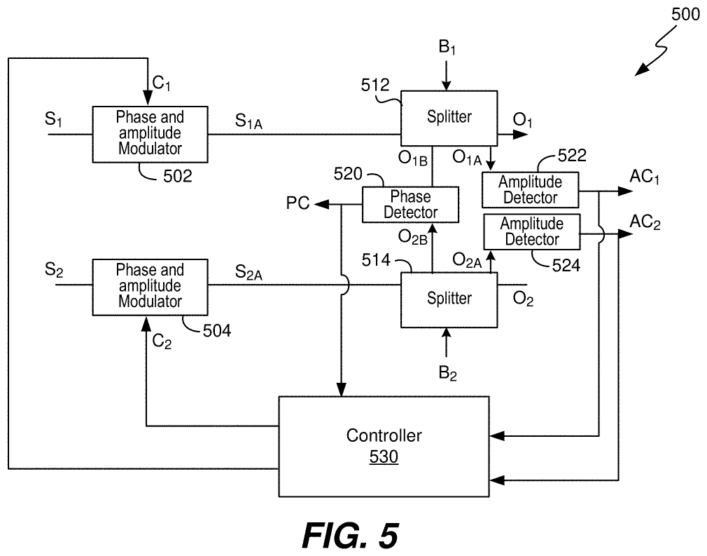

FIG. 5 is a schematic diagram of a two-channel amplitude and phase calibration block 500, in accordance with one embodiment of the present disclosure. Phase and amplitude modulator 502 is adapted to modulate the phase and amplitude of the first input signal S₁ in accordance with control signal C₁ to generate signal S_{1A}. Similarly, phase and amplitude modulator 504 is adapted to modulate the phase and amplitude of the second input signal S₂ in accordance with control signal C₂ to generate signal S_{2A}.

Splitter 512 is adapted to split signal S_{1A} into three signals O₁, O_{1A}, and O_{1B} whose relative powers is determined using signal B₁. In one example, signal B₁ causes the delivery of 98% of the power to output signals O₁, 1% of the power to signal O_{1A}, and the remaining 1% of the power to signal O_{2A}. In other example, signals B₁ may cause the percentages of the power delivered to signals O₁, O_{1A} and O_{1B} to have other values. Amplitude detector 522 receives signal O_{1A}, and in response, generates the first amplitude calibration signal AC₁ delivered to controller 530.

Splitter 514 is adapted to split signal S_{2A} into three signals O₂, O_{2A}, and O_{2B} whose relative powers is determined using signal B₂. In one example, signal B₂ causes the delivery of 98% of the power to output signals O₂, 1% of the power to signal O_{2A}, and the remaining 1% of the power to signal O_{2B}. In other example, signals B₂ may causes the percentages of the power delivered to signals O₂, O_{2A} and O_{2B} to have other values. Amplitude detector 524 receives signal O_{2A}, and in response, generates the second amplitude calibration signal AC₂ delivered to controller 530.

Phase detector 520 receives signals O_{2A} and O₂₈, and in response, generates the phase control signal PC delivered to controller 530. To determine the relative phases of signals O_{2A} and O_{2B}, in one embodiment, phase detector 520 combines signals O_{2A} and O_{2B} to perform interferometry. Controller 530 is adapted to adjust control signals C₁ and C₂ in accordance with the values of the signals AC₁, AC₂, and PC. Although not shown, it is understood that the amplitude and phase calibration block shown in FIG. 5 equally applies to N signal paths receiving N input signals S₁, S₂ . . . S_{N}, where N is an integer greater than or equal to 2.

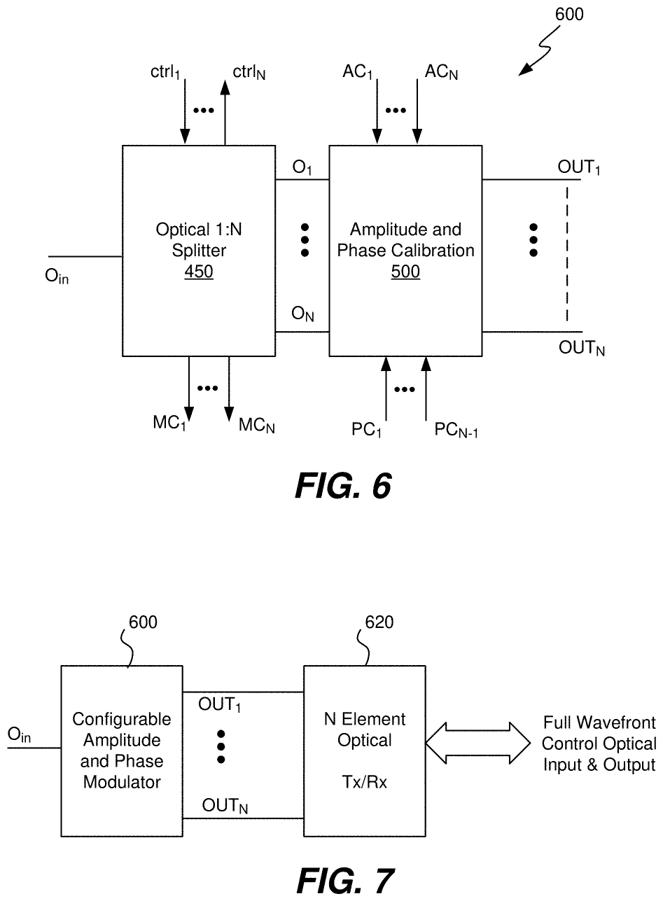

FIG. 6 is a block diagram of a calibratable N-path amplitude and phase modulator (alternatively referred to herein as configurable or programmable amplitude and phase modulator) 600, in accordance with one embodiment of the present disclosure. The configurable amplitude and phase modulator 600 is shown as including, in part, a 1-to-N tunable amplitude modulator 450 (also referred to herein as a splitter), as described above with reference to FIG. 4C. The configurable amplitude and phase modulator 600 is also shown as including, in part, and an amplitude and phase calibration block 500, as described above with reference to FIG. 5.

The phase and amplitude of the signal in each path may be individually calibrated and controlled. The controllers disposed in blocks 450 and 500, which may be analog or digital controllers and which may be a shared controller, are adapted to adjust the phase and amplitude of the signal in each path, as described above.

FIG. 7 shows the configurable amplitude and phase modulator 600 of FIG. 6 supplying its N optical output signals Out₁, Out₂ . . . Out_{N} to an N-element optical transmitter and receiver array 620. The N-element transmitter and receiver array 620 forms the transmit and receive aperture of an optical phased array 620. The transmit array of optical phased array 620 is described above with reference to FIG. 2. The receive array of optical phased array 620 is described below.

### Focal Plane Array

A focal plane array (FPA), in accordance with one embodiment of the present disclosure, includes, in part, an optical splitter tree, a multitude of optical switches that can direct power to any of optical radiators, and a lens. The radiators of the FPA are positioned at the focal distance of the lens. The optical splitter tree and the optical switches may be integrated in the same substrate as the tunable optical switch network.

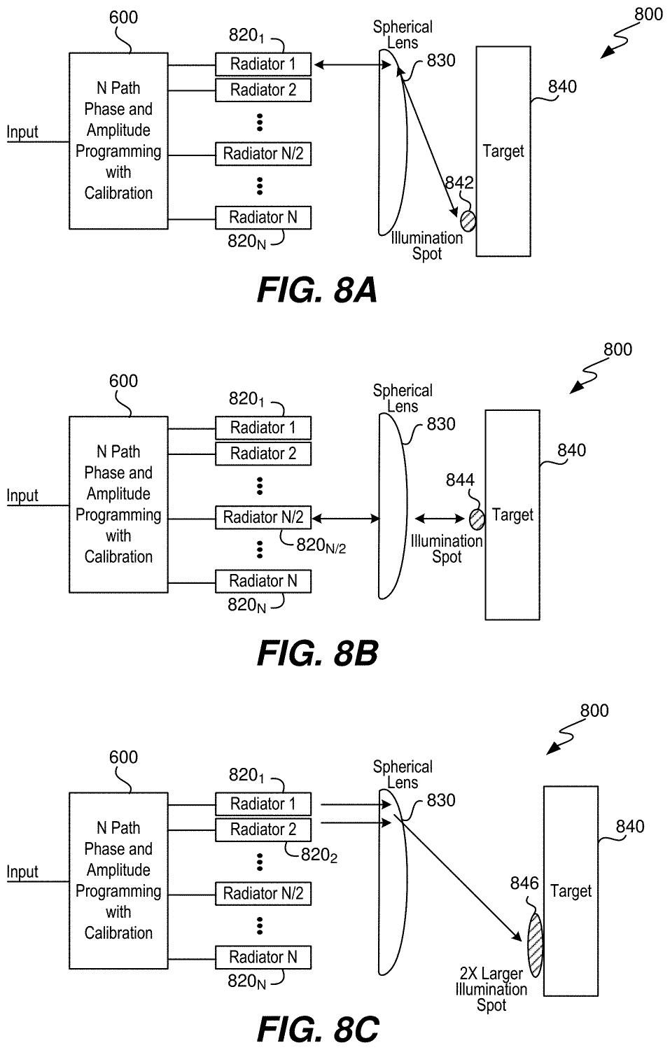

FIG. 8A shows an FPA 800 having disposed therein a lens 830 used to focus the beam radiated by N radiators 820₁, 820₂ . . . 820_{N} on to a target 840. Radiators 820, where i is an index ranging from 1 to N, receive optical signals from configurable amplitude and phase modulator 600, described above with reference to FIG. 6. Radiators 820 are positioned at the focal distance of lens 830.

In FIG. 8A, only one of the N radiators, namely radiator 820₁ is shown as being turned on. The light emitted by radiator 820₁ is shown as being focused by lens 830 at position 842 on target 840. In FIG. 8B, only radiator 820_{N/2} is shown as being turned on. The light emitted by radiator 820_{N/2} is shown as being focused by lens 830 at position 844 on target 840.

In FIG. 8C, two adjacent radiators 8201 and 8202 are shown as being turned on. The light emitted by these two radiators is shown as being focused by lens 830 at position 846 on target 840. The illumination size at position 846 is thus nearly twice the illumination size at positions 842 and 844. The greater the number of radiators that are turned on, the higher is the number of points that can be illuminated on the target. Accordingly, FPA 800 may be operated at a relatively high-speed and low resolution scan using two or more concurrently active radiators to form a course image. Thereafter, one or more of the radiators may be turned off to operate the FPA at a relatively higher resolution to increase the resolution and enhance the image quality. The high-resolution scan may be selectively limited to certain regions of the target to resolve specific features more accurately. A user can select a high-resolution scan of specific regions or directions of the target based on the application that the user is running.

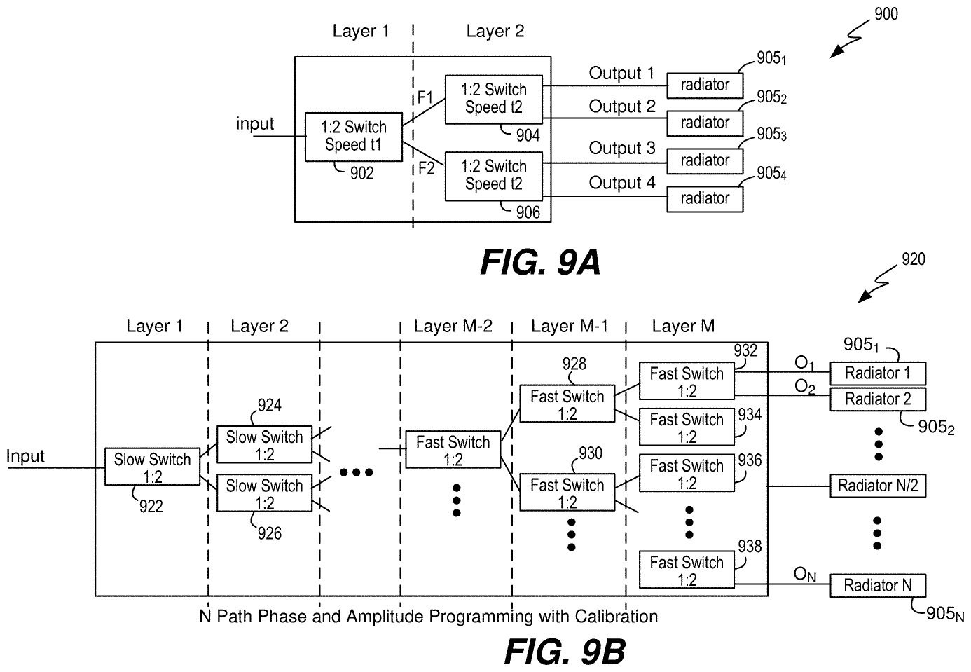

FIG. 9A shows an example of an FPA 900 that includes, in part, four radiators 905₁, 905₂, 905₃ and 905₄. FPA 900 is also shown as including, in part, 2 layers of switching, namely “layer 1” and “layer 2”. The “layer 1” includes a 1:2 optical switch 902 that has a switching speed of t1 and is adapted to deliver the incoming optical signal “input” to one of switches 904 and 906 disposed in layer 2. Switches 904 and 906 have a switching speed of t2 and are adapted to generate output signals output_1, output_2, output_3 and output_4, delivered respectively to radiators 905₁, 905₂, 905₃, and 905₄, as shown. Switches 902, 904 and 906 form a switching network that deliver the input optical signal “input” to the radiators. In some embodiment, switches 902, 904 and 906 are on-off switches. In yet other embodiments, each of switches 902, 904 and 906 may be a signal splitter adapted to split the received signal into a pair of signal in accordance with a desired power ratio.

The switching speed of “layer 2” limits FPA 900's refresh rate, which is defined by the time it takes to switch between all outputs. If switching speeds t1 and t2 are equal, then it takes t1+t2+t1+t2=4×t1 to switch between all states. The refresh rate of the aperture of FPA 900 is the defined by 1/(4t1). If t1>>t2, then it takes t1+t2+t1+t2≈2t1 to switch between all states thus causing the refresh rate to be 1/(2t1) which is twice as fast as ¼t1. It can be seen that if, t2>>t1, the switching time is 4×t2 thus resulting in a refresh rate of 1/(4t2) which is the same rate as when t2=t1.

To improve the performance of the FPA, in accordance with one aspect of the present disclosure, switches disposed in the higher layer(s), which is layer 2 in this example, are selected to be faster than switches disposed in the lower layer(s), which is layer 1 in this example. Therefore, with reference to OPA 900, switches 904 and 906 in layer 2 are selected to be faster than switch 902 disposed in layer 1.

Since the switching network is formed using a cascade of optical switches, the loss contribution of the individual switches may become prohibitively large as the size of the radiator array increases. Thermo-optic or mechanical switches with low loss may be used to form the switching network. However, such switches are slow and can reduce the scan rate and beam steering speed of the transmitter. Faster electro-optic switches have a high loss and make large-scale tunable trees formed with only electro-optic switches impractical.

FIG. 9B shows an FPA 920 that has M switching layers, namely first layer layer_1, second layer layer_2 . . . and M^{th} layer layer_M. Layer layer_1 is shown as including a 1:2 switch 922; layer layer_2 is shown as including 1:2 switches 924, 926; and layer layer_M is shown as including 2^{M} switches four of which, namely switches 932, 934, 936 and 938 are shown for simplicity. Layer layer_M generates N optical signals O₁, O₂ . . . O_{N} that are respectively delivered to radiators 905₁, 905₂ . . . 905_{N}. In accordance with one aspect of the present disclosure, the switches disposed in lowest layer(s), such as switches 922, 924 and 926 disposed in layer_1 and layer_2, are selected to be relatively slow (high power efficiency) thermo-optic switches. Switches disposed in the highest layer(s), such as the switches disposed in layers layer_M−2 and layer_M−1 and layer_M, are selected to be relatively fast (lower power efficiency) electro-optic switches. An FPA, in accordance with embodiments of the present disclosure, is reconfigurable to provide both a high-resolution at a slower scan rate, and a relatively lower resolution at a relatively higher scan rate, as is described above with respect to the OPAs.

### Hybrid FPA/OPA (HFPA)

An FPA requires less control circuitry compared to an OPA. An Nₓ×N_{y} radiator FPA requires log(2, Nₓ×N_{y}) concurrently active control signals while an OPA requires Nₓ×N_{y} concurrently active control signals. In addition, the relatively smaller apertures of FPAs have lower transmitter loss compared to their OPA counterparts. However, the scalability of FPAs remains a challenge due to their increased loss and reduced switching speed. Moreover, the high-intensity signal in an FAP travels through an entire switching network for a given setting which makes the signal susceptible to non-linear optical effects such as two-photon absorption, whereas in an OPA, the high-intensity optical signal is distributed between different paths near the input circuitry of an OPA hence resulting in substantially lower signal degradation from optical nonlinearity effects.

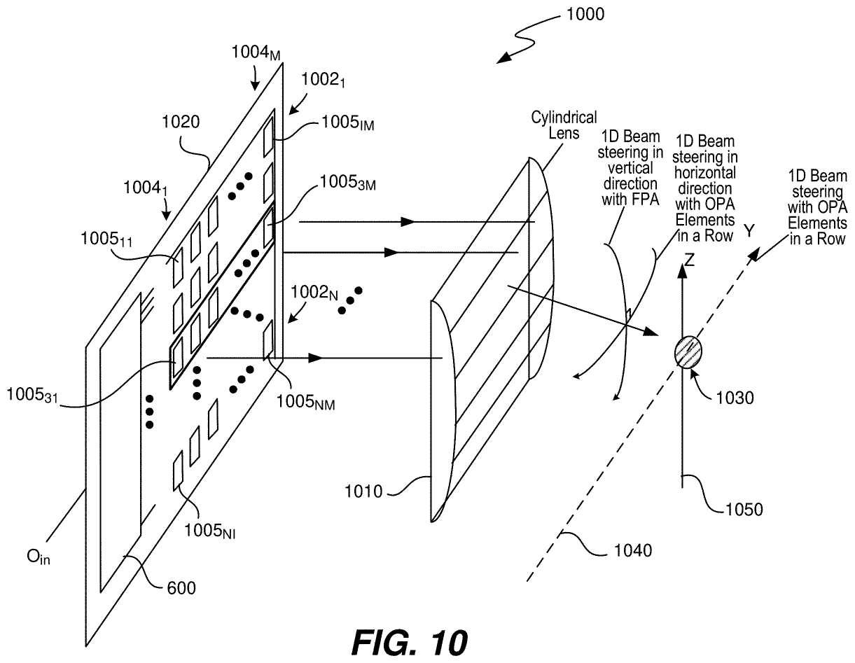

FIG. 10 show a hybrid optical phased array transmitter 1000 which includes, in part, a two-dimensional array of radiators 1020 positioned in front of a cylindrical lens 1010. The two dimensional array of radiators 1005ᵢⱼ is arranged along N rows and M columns, where i represents a row index of the radiator ranging from 1 to N, and j represents a column index of the radiator ranging from 1 to M in this example.

Two-dimensional array of radiators 1020 is also shown as including, in part, a configurable amplitude and phase modulator 600, as described above with reference to FIG. 6, that distributes the incoming optical signal Oᵢₙ to the array of radiators. Cylindrical lens 1010 is positioned such that the center of the aperture of the array of the radiators is positioned along the center axis of the cylindrical lens and is at the focal distance of the cylindrical lens. Beamforming in the vertical direction is achieved by means of the focal plane array. When only a single radiator 1005ᵢⱼ is active, a horizontal line is projected on a target positioned to the right of lens 1010.

To achieve beamforming in the horizontal direction (i.e., parallel to the axis of the cylindrical lens), the phases of the radiators disposed in a row of the array (e.g., radiators 1005₃₁ . . . 100_{3M} positioned along the third row) are shifted. For example, the position of illuminated spot 1030 formed by the radiators in row 3 of the array of radiators may be changed along y-axis 1040 (which is parallel to the axis of the cylindrical lens) by varying the phases of the radiators in row 3 of the array. By turning off row 3 of the radiators, and turning on another row of the radiators, the position of spot 1030 may be changed along z-axis 1050, which is perpendicular to the y-axis.

For example, by turning off row 3 of the radiators and turning on row 4 of the radiators, spot 1030 is moved in the positive direction along the z-axis. Similarly, by turning off row 3 of the radiators and turning on row 2 of the radiators, spot 1030 is moved in the negative direction along the z-axis. Therefore, beamforming of the hybrid optical phased array transmitter 1000 is achieved by activating one row of radiators to move the beam along the z-axis, and shifting the phases of the radiators on the activated row to move the beam along the y-axis.

### Receiver Sub-System

An optical receiver array, in accordance with embodiments of the present disclosure, may be an OPA, an FPA, or a hybrid of OPA and FPA.

### Receiver Direction of Arrival Estimation (DOA)

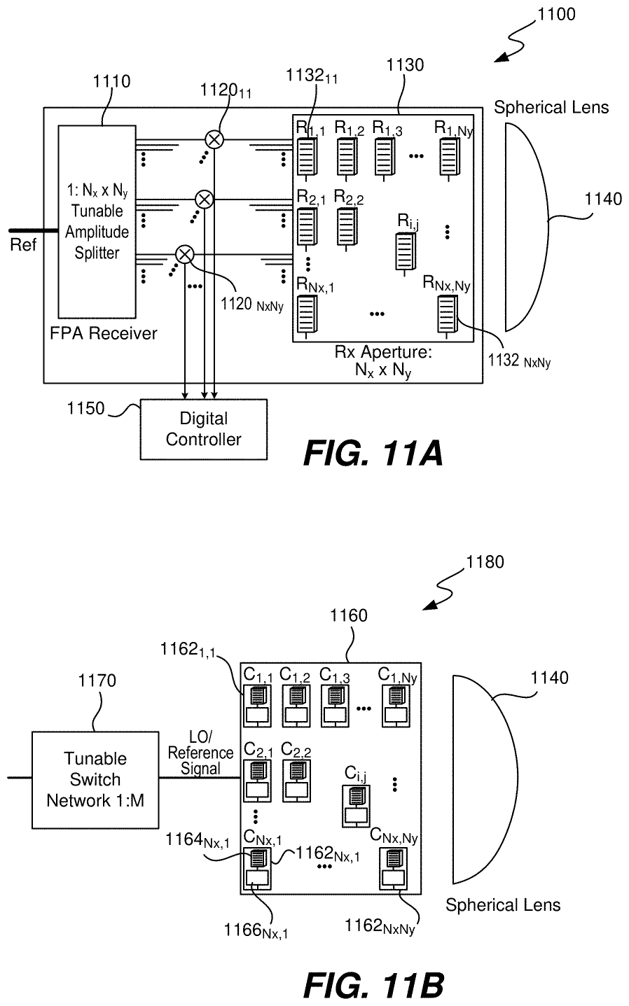

FIG. 11A is a simplified high-level block diagram of an optical phased array receiver 1100, in accordance with one embodiment of the present disclosure. Optical phased array receiver 1100 is shown as including, in part, an Nₓ×N_{y} array 1130 of receive elements 1132ᵢⱼ, where i is a row index varying from 1 to N_{y} and j is a column index varying from 1 to Nₓ in this example. Optical phased array receiver 1100 is also shown as including, in part, an Nₓ×N_{y} tunable amplitude splitter 1110 (which is similar to FPA 920 shown in FIG. 9B) that splits the received reference optical signal Ref into Nₓ×N_{y} optical signals each delivered to a different one of the Nₓ×N_{y} mixers 1120ᵢⱼ.

Each mixer also receives the optical signal received by one of the receive elements 1132ᵢⱼ. The output of each mixer 1120ᵢⱼ is delivered to digital controller 1150 that detects the optical signal received by the receiver array. In one embodiment, optical phased array receiver 1100 is also shown as including, in part, an optical lens 1140 that directs the received light onto the Nₓ×N_{y} array 1130 of receive elements 1132ᵢⱼ. Array 1130 is positioned at the focal distance of lens 1140.

FIG. 11B is a simplified high-level block diagram of an FPA receiver 1180, in accordance with another embodiment of the present disclosure. FPA receiver 1180 is shown as including, in part, an Nₓ×N_{y} array 1160 of receive elements 1162ᵢⱼ, where i is a row index varying from 1 to N_{y} and j is a column index varying from 1 to Nₓ in this example. FPA receiver 1180 is also shown as including a 1:M tunable switch network 1170 (similar to those described above with reference to FIGS. 9A and 9B) that delivers a reference local oscillator (LO) optical signal to each of the receive elements 1162ᵢⱼ, where M is equal to Nₓ×N_{y}.

Each receiver element 1162ᵢⱼ includes, in part, a grating coupler 1164ᵢⱼ, and a photo-diode 1166ᵢⱼ. For example, receiving element 1162_{N}_{ₓ}₁ is shown as including, in part, a grating coupler 1164_{N}_{ₓ}₁, and a photo detector 1166_{N}_{ₓ}₁. Although not shown, each receiving element also includes a mixer receiving an associated LO reference signal that is used to down-convert the frequency of the optical signal received by the mixer's associated grating coupler and photo-diode and supply the down-converted signal to a controller, not shown in FIG. 11B. FPA receiver 1180 is also shown as including, in part, an optical lens 1140 that directs the received light onto receive elements 1162ᵢⱼ of array 1160. Array 1180 is positioned at the focal distance of lens 1140.

The receivers shown in FIGS. 11A and 11B may be IQ receivers configured to use 0° and 90° optical path difference between the two channels in each cell. The receiver elements in the receivers may be multi-phase (for example, the receiver cell can output 0°, and 60°, and 120° optical path differences) to improve optical phase detection accuracy.

### Adaptive Transceiver Beamforming

The transmitters and receivers described above may be combined in a number of different ways to achieve the desired performance depending on the application. For example, an FPA transmitter and receiver may be configured as a monostatic or bi-static transceiver. Alternatively, an OPA transmitter may be combined with an FPA receiver, or vice-versa. Furthermore, as described above, the transmitter and receiver beams may be multiplexed. For example, a transmitted beam may be collected (i.e., received) by a multitude of receiver cells so as to benefit from a reduce size and complexity of the transmitter aperture.

For example, if a single transmitter beam S_{i,j} illuminates N₁×N₁ receiver spots, then for an Nᵣ×Nᵣ receiver aperture size, the transmitter aperture needs to be able to project only (Nᵣ/N₁)×(Nᵣ/N₁) spots.

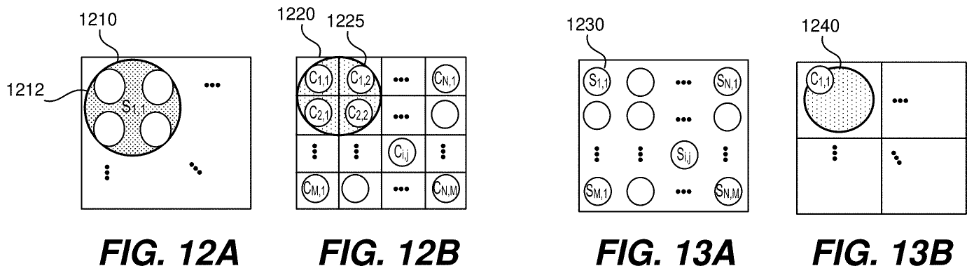

FIG. 12A shows a transmitted beam having a width defined by perimeter line 1210 which encloses the 4 spots defined by perimeter line 1212, each of which may be separately generated when, for example, the entire transmitter array is activated. FIG. 12B shows a corresponding receiver aperture size (collection area) that has been selected to discern spot size 1220 that encloses the four distinct spot sizes 1225 (i.e., C₁₁, C₁₂, C₂₁, C₂₂) that the receiver may discern when, for example, an entire array of the receiver is activated.

FIG. 13A shows a transmitted beam having a width defined by perimeter line 1230 and generated when, for example, the entire transmitter array is activated. FIG. 13B shows a corresponding receiver aperture size selected so as to discern the spot defined by perimeter line 1240 covering an area which is, for example, nearly four times larger than the area defined by perimeter line 1230.

A challenge with transmitter beam multiplexing is that the transmitter beam in its entirety may not impinge on the individual receiver cells due to mismatches between the transmitted beam(s) and the received beam(s), thereby causing inefficiencies. In accordance with one aspect of the present disclosure, a micro-lens array may be disposed on the transmitter aperture to focus the multiplexed beam on to a desired spot. In one embodiment, a micro lens may be used for each transmitter element. In another embodiment, a micro lens may be used for a group of transmitter elements, such as one micro lens for a group of 4 transmitter elements, or one micro lens for a group of 8 transmitter elements. Similarly, in accordance with one aspect of the present disclosure, a micro-lens array may be disposed on the receiver aperture to enhance the focusing of the received light. In one embodiment, a micro lens may be used for each receiver element. In another embodiment, a micro lens may be used for a group of receiver elements, such as one micro lens for a group of 4 receiver elements, or one micro lens for a group of 8 receiver elements. It is understood that the micro lens array may be used in addition to the lens described in detail above.

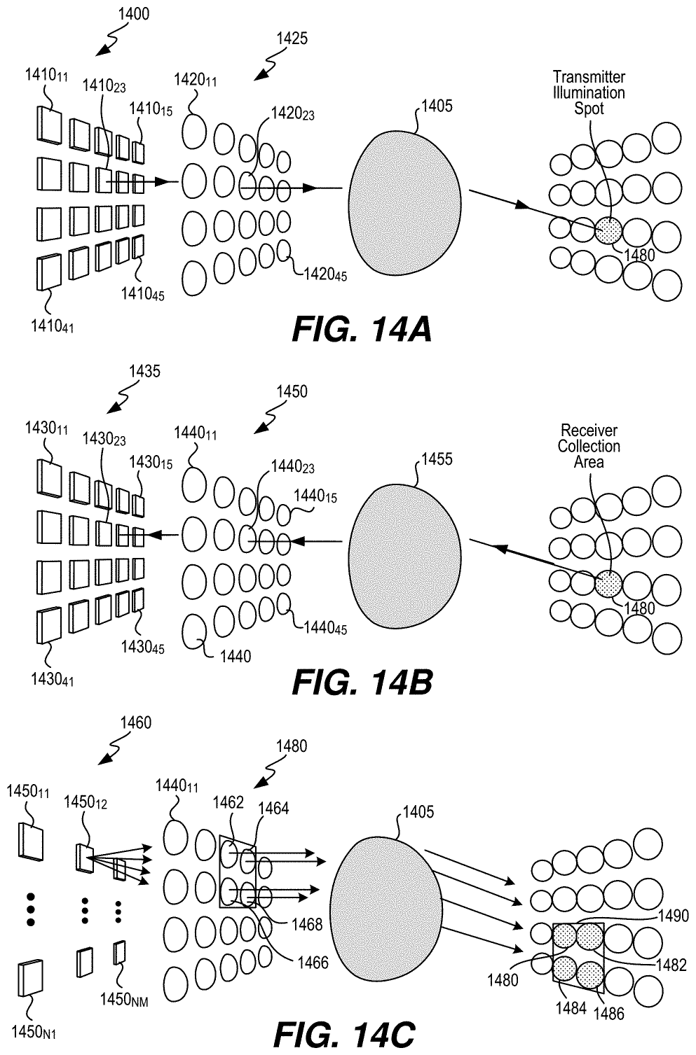

FIG. 14A shows an exemplary array 1400 of radiators 1410j of a transmitter of an adaptive LiDAR, where i is a row index ranging from 1 to 4 and j is a column index ranging from 1 to 5. Associated with each radiator 1410ᵢⱼ in the adaptive LiDAR is a micro-lens 1420ᵢⱼ that receives the light from its associated radiator. Micro-lenses 1420ᵢⱼ form a corresponding micro-lens array 1425 of the LiDAR. For example, as shown, micro-lens 1420₂₃ directs the optical beam received from its associated radiator 1410₂₃ on to spot 1480 of the target via lens 1405.

FIG. 14B shows an exemplary array 1450 of receive elements 1430ᵢⱼ of a receiver of an adaptive LiDAR, where i is a row index ranging from 1 to 4 and j is a column index ranging from 1 to 5. Associated with each receive element 1430ᵢⱼ in the adaptive LiDAR is a micro-lens 1440ᵢⱼ that directs the light received from an illuminated spot on the target—via lens 1455—to an associated receive element 1430ᵢⱼ. Micro-lenses 1420ᵢⱼ form a corresponding micro-lens array 1460 of the LiDAR. For example, as shown, micro-lens 1440₂₃ directs the optical beam received from illuminated spot 1480 of the target—via lens 1455—to its associated receive element 1430₂₃.

FIG. 14C shows an exemplary array 1460 of radiators 1450ᵢⱼ of a transmitter of an adaptive LiDAR, where i is a row index ranging from 1 to N and j is a column index ranging from 1 to M. Associated with each radiator 1450ᵢⱼ in the adaptive LiDAR is a group of micro-lens (four in this example) that receive the light from their associated radiator. The micro-lenses form a corresponding micro-lens array 1480 of the LiDAR. For example, as shown, micro-lenses 1462, 1464, 1466, and 1468 are shown as directing the optical beam received from their associated radiator 145012 on to spots 1480, 1482, 1484 and 1484 of the target via lens 1405. Spots 1480, 1482, 1484 and 1484 collectively define region 1490 of the target that is illuminated. Micro-lenses 1462, 1464, 1466, and 1468 are disposed along adjacent row and columns of the micro-lens array, as shown. Although not shown, it is understood that in yet other embodiments, each receive element of a receiver of a LiDAR may be associated with a group (e.g., four) of micro-lenses.

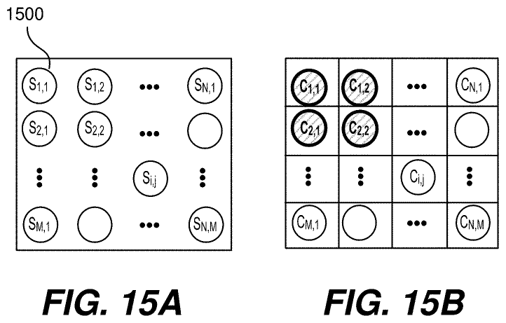

FIG. 15A shows examples of M×N spot sizes that may be illuminated along the two-dimensional array 1500 by a transmitter adapted to include a micro lens array. The spot sizes are designated as Sᵢⱼ, where i is an index ranging from 1 to M, and j is an index ranging from 1 to N. FIG. 15B shows a corresponding M×N spot sizes that may be discerned by a receiver adapted to include a micro lens array. The spot sizes are designated as Cᵢⱼ, where i is an index ranging from 1 to M, and j is an index ranging from 1 to N. Beam multiplexing, in accordance with embodiments of the present disclosure and as described above, may be used in both the transmitters and receiver that include micro lens arrays.

### Adaptive Multi-Beam Transceiver

The transmitter and receiver beam sizes can have adaptive beam diameter control as described above. The transceiver may have several modes of operation that enable the transceiver to perform a tradeoff between the scan rate of the transceiver and its resolution. A high-resolution transceiver with narrow beams can discern a large number of points in the far-field. Such a transceiver will have a relatively slower scan rate when scanning a relatively large number of points at a high resolution in the far-field.

The transceiver can scan a relatively smaller number of points in the far-field (i.e., smaller field of view or FOV) with the same scan rate. Alternatively, the transceiver can scan a relatively large number of points at a relatively higher scan rate but a reduced resolution. Such adaptive control can be used in an iterative process to increase the quality of the section of the image that may have a relatively low signal-to-noise ratio (SNR), and a higher range accuracy to improve the quality of an image of a particular portion of a target.

A transceiver array with a relatively large beam width beam may scan the far-field at a higher refresh rate which can be desired for many applications. For an OPA, a low-resolution mode can be used for course scene and target approximation. The beam size may be enlarged by redirecting the power to a subset of the radiators. For an FPA, the beam size can be reduced by directing the power to adjacent transmitter elements. Alternatively, the receiver aperture can subsample the received light by not collecting light from specific segments of the receiver aperture. For example, if the receiver aperture is directed to collect light from every other element, the scan rate of the transceiver increases by a factor of four. However, the transceiver will be subsampling the far-field by the same factor.

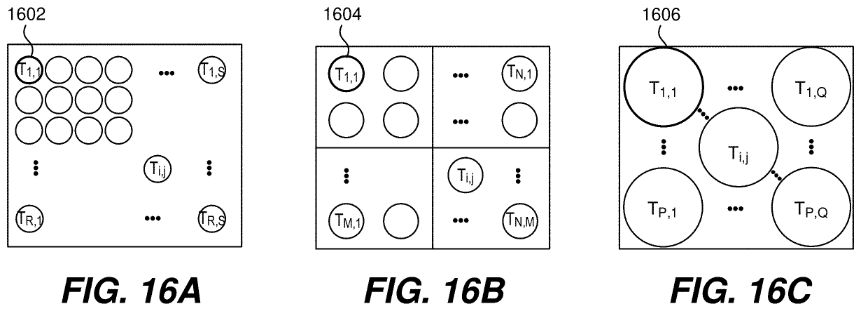

FIG. 16A shows an example of a far-field radiation pattern (i.e., illuminated points on a target) of a transceiver at a relatively high resolution and a relatively low refresh rate, in accordance with one embodiment of the present disclosure. In FIG. 16A the illuminated spot size is shown as having an area defined by perimeter line 1602. FIG. 16B shows a far-field radiation pattern of the same transceiver as that used in FIG. 16A. However, in FIG. 16B, the transmitter is selected to operate at an intermediate resolution and an intermediate refresh rate. Accordingly, in FIG. 16B the illuminated spot size is shown as having an area defined by perimeter line 1604, which is larger than the area defined by perimeter line 1602 of FIG. 16A. FIG. 16C shows a far-field radiation pattern of the same transceiver as that used in FIGS. 16A and 16B. However, in FIG. 16C, the transmitter is selected to operate at a relatively low resolution and a relatively high refresh rate. Accordingly, in FIG. 16C the illuminated spot size is shown as having an area defined by perimeter line 1606, which is larger than the area defined by perimeter line 1604 of FIG. 16B.

### Laser Amplification

The laser that generates a coherent signal, the time-domain encoding, and the laser amplification may be formed in a number of different ways. In accordance with one techniques, a frequency modulated continuous wave (FMCW) chirp signal is used for modulation of the laser current (concurrent generation of coherent light and the FMCW signal). The laser signal is subsequently amplified using an optical amplifier, such as Ebrium-doped fiber amplifier (EDFA), or a semiconductor optical amplifier (SOA).

The advantage of an SOA is that it can be integrated with a number of integrated photonic processes with active gain material such as Indium Phosphide (InP) manufacturing processes. The time-domain encoding signal can be applied using an optical phase modulator, amplitude modulator, or a single-side-band (SSB) modulator, which is advantageous since more complex time-domain encoding schemes, including phase-coded signals, dual-chirp, or multi-tone signals, may be applied. Furthermore, since the frequency of the laser is constant, the laser drive complexity may be substantially reduced. The time-domain encoded laser signal can be amplified before directing the power to the transmitter and receiver apertures.

The optical amplifier can be set to compensate for the transmitter aperture loss such that the maximum permissible optical power (following safety standards) is radiated from the aperture. If the optical amplifier provides the required pre-transmit power without optical power saturation for any given application, a single optical amplifier may be sufficient. Otherwise, multiple optical amplifier outputs may be combined to increase the total optical power; this can be achieved by coherently combining the output of the amplifiers.

A series of tunable phase shifters may be placed at the output of each optical amplifier to maximize the combined power of all signal paths. In the case of OPA with tunable feedback control, the optical power need not be combined prior to coupling to the transmitter and receiver aperture since the feedback control of the OPA is sufficient to align the relative optical phase of different transmitter or receiver paths.

Furthermore, the power amplifiers can be dynamically enabled or disabled. The disabled power amplifiers limit the transmit power to only a particular section of the transmit aperture, resulting in a decrease of the size of the transmitter aperture. In other embodiment, all the outputs can be combined to a single path before distributing the signal to different points in the FPA.

In accordance with one aspect of the present disclosure, the power of the laser used in an optical transmitter or receiver array may be increased or decreased. For example, if a low resolution scan of a target that is relatively close to the transmitter (e.g., the target is several meters away from the transmitter array), the laser power may be reduced. In contrast, when a high resolution scan of a target that is relatively far from the transmitter (e.g., the target is hundreds of meters away from the transmitter array), the laser power may be increased. To achieve this, in accordance with one embodiment of the present disclosure, the laser beam is split and delivered to a multitude of semiconductor power amplifiers (SOAs) each adapted to amplify the received laser beam, as described further below.

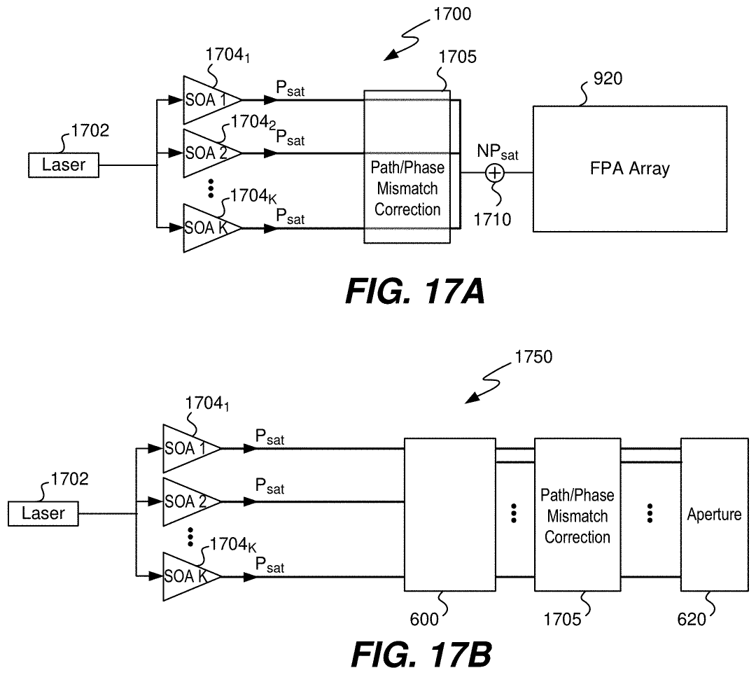

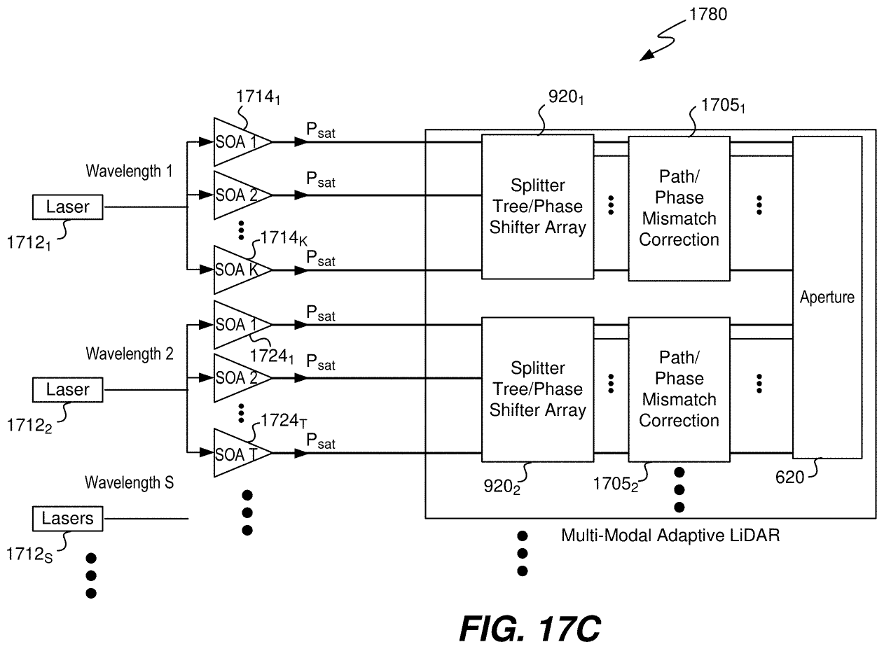

FIG. 17A is a block diagram of an adaptive LiDAR transmitter 1700, in accordance with one embodiment of the present disclosure. LiDAR transmitter 1700 is shown as including, in part, a laser source 1702, K SOAs 1704₁, 1704₂ . . . 1704_{K} where K is an integer, a path/phase mismatch correction block 1705, and a configurable phase and amplitude modulator 920, as described above with reference to FIG. 9B. It is understood that K may be equal to or smaller than N.

Each SOA 1704ᵢ, where i is an index ranging from 1 to K, receives the laser beam from laser source 1702, amplifies the received laser beam and delivers the amplified beam to path/phase mismatch correction block 1705. Path/phase mismatch correction block 1705 is adapted to change the phases of the received beams, as necessary, so as to cause the beams to have the same phase. In one embodiment, path/phase mismatch correction block 1705 operates using an interferometer, as was described with reference to FIG. 3. Summation block 1710 adds the K in-phase beams supplied by path/phase mismatch correction block 1705 and delivers the resulting beam to layer 1 of FPA 920, described in detail above with respect to FIG. 9B.

FIG. 17B is a block diagram of an adaptive LiDAR transmitter 1750, in accordance with one embodiment of the present disclosure. LiDAR transmitter 1750 is shown as including, in part, a laser source 1702, K SOAs 1704₁, 1704₂ . . . 1704_{K} where K is an integer, a path/phase mismatch correction block 1705, a configurable amplitude and phase modulator 600, as described above with reference to FIGS. 6 and 7, and a transmitter aperture, also described above with reference to FIG. 7. It is understood that K may be equal to or smaller than N.

Each SOA 1704ᵢ, where i is an index ranging from 1 to K, receives the laser beam from laser source 1702, amplifies the received laser beam and delivers the amplified beam to configurable amplitude and phase modulator 600. Path/phase mismatch correction block 1705 is described above with reference to FIG. 17A. Aperture 620, which includes an array of optical transmitters, radiates optical beams in accordance with the output beams of path/phase mismatch correction block 1705.

FIG. 17C is a block diagram of a multi-modal adaptive LiDAR 1780, in accordance with one embodiment of the present disclosure. Adaptive LiDAR 1780 is shown as including, in part, S configurable amplitude and phase modulators 920₁, 920₂ . . . 920_{S} each of which corresponds to configurable phase and amplitude modulator 920, as described above with reference to FIG. 9B. Adaptive LiDAR 1780 is also shown as including, in part, S path/phase mismatch correction block 1705ᵢ, each of which is adapted to change the phases of the beams it receives so as to cause them to have the same phase, and a transmitter aperture, where i is an index ranging from 1 to S in this example.

Adaptive LiDAR 1780 includes S laser sources 1712ᵢ, each having a different wavelength. The beam from laser source 1712₁ is shown as being split into K beams each of which is amplified by an associated SOA 1714ⱼ, where j is an index ranging from 1 to K, and delivered to configurable phase and amplitude modulator 9201. Similarly, the beam from laser source 1712₂ is shown as being split into P beams each of which is amplified by an associated SOA 1724_{T}, where T is an index ranging from 1 to T, and delivered to configurable phase and amplitude modulator 920₂.

In adaptive LiDAR 1780, a user can adjust the output power level by activating the multitude of the optical amplifiers to achieve the desired performance. Furthermore, adaptive LiDAR 1780 may self-calibrate and adjust the total output power for better performance or to conserve power. Moreover, the user may operate the adaptive LiDAR in a multi-modal fashion with different lasers each operating at the same or different wavelength, thereby enabling multi-frequency spectral imaging as well as and enhanced LiDAR beamforming and beam steering.

### Time-Domain Encoding

In accordance with one aspect of the present disclosure, the transmitter signals is encoded before being directed to a target. Such time-domain encoding may be performed on the fly for different operations The encoding may include a linear frequency chirp with up and down ramps. The difference between the up and down ramps may then be used to determine both the distance and the velocity of a target. Alternatively, a phase-coded waveform can be used, which improves clutter rejection at the cost of increased signal encoding complexity.

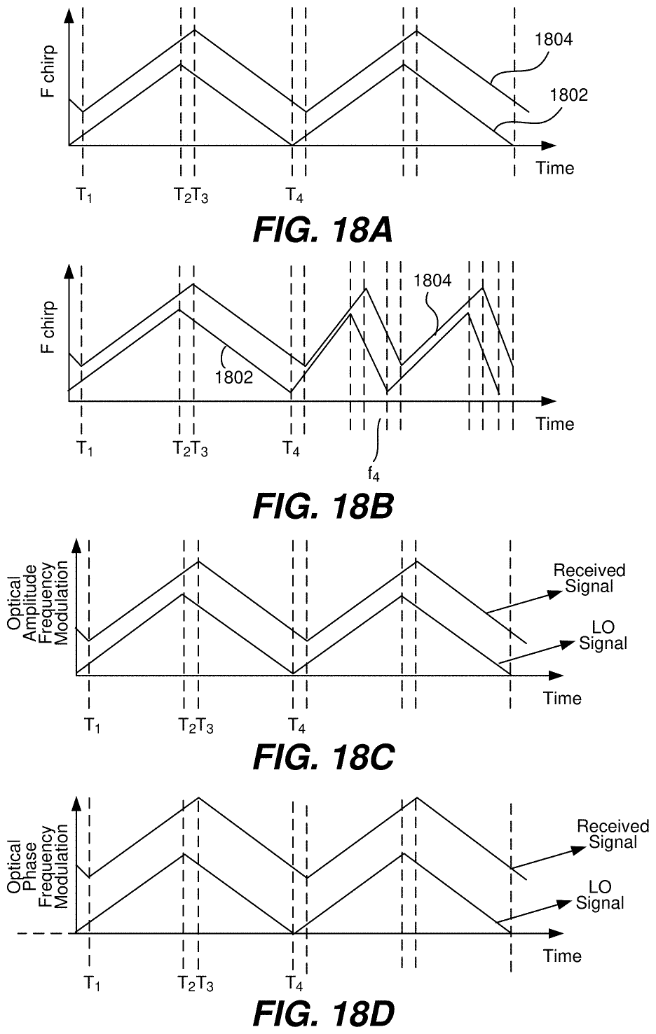

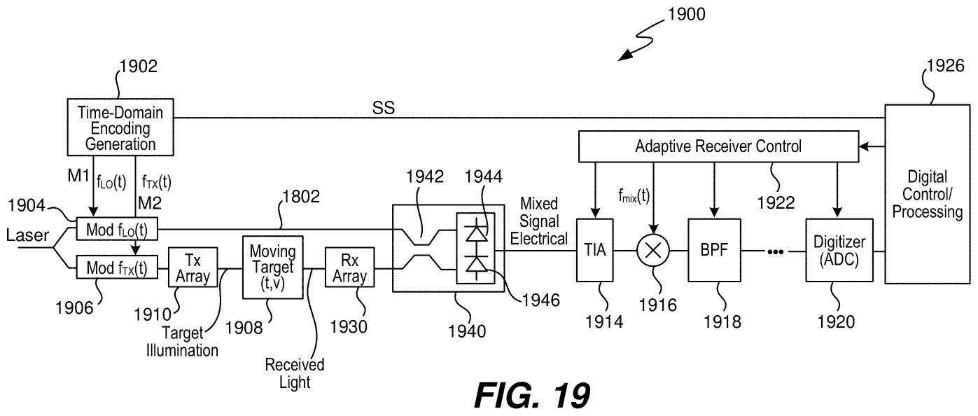

FIG. 18A shows the linear ramp in frequency of the reference LO signal 1802 and as well as the signal 1804 received from the target. Lo signal 1802 and the light signal received from the target are also shown with reference to FIG. 19 described in detail below. Signals 1802 and 1804 are mixed and converted to an electrical signal S, as is also shown and described with reference to FIG. 19. During the time interval between T₁ and T₂, the frequency of signal S is defined by (f₁+f₀). Similarly, during the time interval between T₃ and T₄, the frequency of signal S is defined by (f₂+f₀). Frequencies f₁ and f₂ represent offset frequencies from a nominal frequency f₀. The average of the frequencies f₁ and f₂ is representative of the distance of the target. The difference between frequencies f₁ and f₂ is representative of the velocity of the target.

FIG. 18B is similar to FIG. 18A except that in FIG. 18B the linear ramping of the chirp frequency is varied during different time periods. By changing the slope of the frequency ramp during different time intervals, the accuracy and resolution with which the target's distance and velocities are determined may be changed.

FIG. 18C shows a linear ramp in frequency of a first chirp FMCW signal used to modulate the amplitudes of a reference LO signal as well as the light signal received from the target, and FIG. 18D shows a linear ramp in frequency of a second chirp FMCW signal used to modulate the phases of the reference LO signal as well as the light signal received from the target, in accordance with another embodiment of the present disclosure.

The multi-tone results obtained during time intervals (T₂−T₁) and (T₄−T₃) may be used for Vernier type high-resolution range determination, or fine and course ranging. Accordingly, by applying a chirp signal to both the amplitudes and phases of the LO signal and the light signal received from the target, a tradeoff in the determination of the dynamic range as well as the resolution for both the range and the velocity of the target may be made to enhance the performance of a LiDAR.

FIG. 19 is a block diagram of a number of components disposed in an adaptive LiDAR 1900 that performs, in part, time-domain encoding, in accordance with one aspect of the present disclosure. The laser beam is shown as being split into two beams delivered to modulators 1804 and 1806. Modulator 1904 is adapted to modulate the phase or amplitude of the laser beam it receives using signal M₁ supplied by time-domain encoder 1902. Signal M1 has a frequency of f_{LO}. The laser beam modulated by modulator 1904 operates as an LO reference signal and is applied to adaptive phased array transceiver 1910. Modulator 1906 is adapted to modulate the phase or amplitude of the laser beam it receives using signal M₂ supplied by time-domain encoder 1902. Signal M₂ has a frequency of f_{TX}. The laser beam modulated by modulator 1906 is used by the transmitter array 1910 of the adaptive transceiver array to illuminate moving target 1908.

The light reflected off the illuminated moving target 1908 is received by receiver array 1930 of the adaptive transceiver array and delivered to optical receiver 1940. Optical receiver 1940 also receives the reference LO light signal 1802. Optical receiver 1940 includes an optical splitter 1942 and back-to-back photo-diodes 1944 and 1946. In response, optical receiver 1940 splits and combines the LO signal and the optical signal received from the receiver array 1930 and converts the resulting signals to an electrical signal S. Signal S is subsequently amplified by transimpedance amplifier (TIA) 1914, down-converted by frequency downconverter 1916, filtered by bandpass filter (BPF) 1918, and digitized by analog-to-digital (ADC) 1920 before being applied to digital control/processing block 1924.

Time-domain encoder 1902 may be adaptively adjusted based on LiDAR 1900's requirements, self-calibration (i.e., LiDAR 1900 calibrates itself), SNR enhancement, and the like, in accordance with the signal SS that time-domain encoder 1902 receives from digital control/processing block 1924. Time-domain encoder 1902 may also be adaptively adjusted based on the requirements specified by user 1926 via digital control/processing block 1924.

Moreover, TIA 1914, downconverter 196, BPF 1918 and ADC 1920 are controlled by adaptive receiver control 1922. Adaptive receiver control 1922, may be dynamically adjusted by the digital control/processing block 1924 during a self-calibration or self-adjustment of LiDAR 1900, or based on the requirements specified by user 1926.

For time-domain encoding, the time domain frequency modulation of the two paths can be adjusted with built-in adaptive control for different scenarios. In the case of FMCW modulation, the rate of the chirp and the zero-distance frequency offset of the two paths can be adjusted to obtain the desired mixed component in a particular frequency range.

A challenge with time-domain encoding is the relatively large receiver chain bandwidth and ADC sampling rate requirements. In the case of FMCW time-domain encoding, the distance from the target may be converted to a down-converted frequency component, as described above. The number of resolvable frequencies for any given chirp is defined by the chirp period, chirp bandwidth, SNR, as well as the signal acquisition time, any one of which factors may limit the LiDAR in dynamic range and resolution, and increase the bandwidth requirement of the receiver.

An adaptive time-domain encoding, in accordance with one aspect of the present disclosure, may adjust the chirp rate and cause the down-converted mixed signals to be at a relatively low frequency so as to reduce the receiver chain bandwidth requirements and power consumption, as described above with reference to FIG. 18B. The minimum detectable range can be increased by increasing the chirp rate. Fora fixed sampling period Tₛₐₘₚₗₑ=T_{chirp}, the minimum detectable range can be increased using the chirp bandwidth ΔF=ζT_{chirp}.

An adaptive time-domain encoder, in accordance with one aspect of the present disclosure, adjusts the time-domain encoding waveform so that the resulting down-converted signal contains multiple frequency tones in order to reduce the receiver bandwidth requirements. For example, the chirping may have two or more chirp rates that are frequency or time-domain multiplexed. The slow chirp provides a high detection range, whereas the fast chirp provides a higher resolution.

The dual chirp modulation may be achieved by encoding one time-domain waveform in the phase of the optical signal and the other one in the amplitude of the optical signal using single sideband (SSB) modulators, as described above with reference to FIGS. 18C and 18D. Assume that the electrical input signals to the SSB modulators at the SSB modulators operation point are represented by:

V₁(t)=A cos(f₁(t)t)+B sin(f₂(t)t); and

V₂(t)=A cos(f₁(t)t)+B cos(f₂(t)t)

The optical output signal of the SSB modulator may then be represented by:

P(t)=A cos(f1(t)t)cos(ωoptt+φopt+f2(t)t)

An IQ receiver cell may then be used, in accordance with embodiments of the present disclosure, to determine both the amplitude and phase of the mixed signal components for high precision multi-mixed tone time-domain encoding.

Referring to FIG. 19, TIA 1914 has a relatively high gain and a low input-referred noise so that the electrical noise of the receiver chain shown in FIG. 19 is dominated by the thermal noise of the feedback resistor disposed in TIA 1914 (not shown). To prevent oscillation and signal degradation that may otherwise result from a relatively large gain of the receiver—that may be achieved using multiple gain stages—a heterodyne and/or super-heterodyne electrical receivers may be used to shift the frequency of the received signal.

A peak detector circuit may also be included in the receiver chain to detect the strength of the received signal and the amplification that may be required to detect the signal efficiently. The frequency of the received down-converted signal may be adaptively detected using a fast Fourier transform (FFT), the multiple signal classification (MUSIC) algorithm, or time-domain phase and frequency estimation methods depending on the strength of the signal and duration of the integration time.

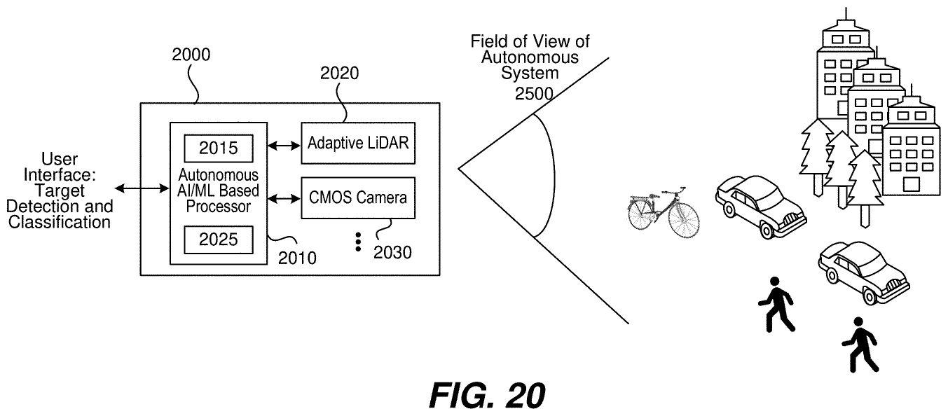

FIG. 20 is a simplified view of an autonomous imaging system 2000, in accordance with one embodiment of the present disclosure. Autonomous imaging system 2000 is shown as including, in part, an artificial intelligence (AI) and/or machine learning (ML) system (referred to alternatively herein as AI/ML) 2010, an adaptive LiDAR 2020 as described above with reference to any of the embodiments of the present disclosure described, and a CMOS camera 2030. AI/ML 2010, which is shown as including, in part, a trained neural network 2015, and computing system 2025, is adapted to operate and use the information received from adaptive LiDAR 2020 and CMOS camera 2030 to provide imaging modality for adaptive and precision detection of position, velocity and classification of objects (e.g., people, bicycles, cars) that are in the field of the view 2500 of the imaging system.

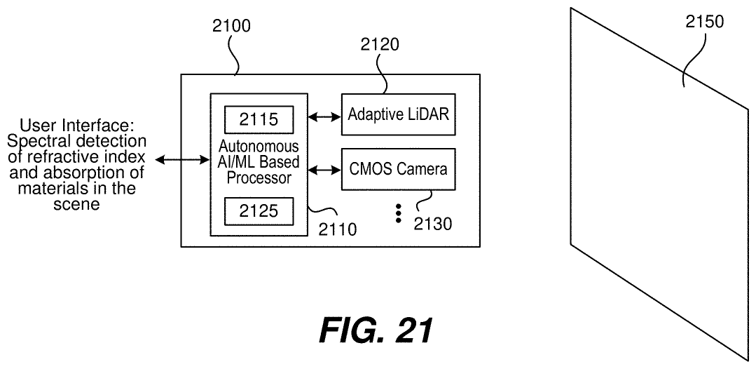

FIG. 21 is a simplified view of a material detection system 2100, in accordance with one embodiment of the present disclosure. Material detection system 2100 is shown as including, in part, an AI/ML 2110, an adaptive LiDAR 2120 as described above with reference to any of the embodiments of the present disclosure described, and an optional CMOS camera 2130. AI/ML 2010, which is shown as including, in part, a trained neural network 2115, and computing system 2125, is adapted to operate LiDAR 2120 as a spectral and interferometric imaging system to detect the absorption and refractive index of the imaged target 2150 so as to detect and classify the material of target 2150.

The above embodiments of the present disclosure are illustrative and not limitative. Embodiments of the present disclosure are not limited by the dimension(s) of the array or the number of transmitters/receivers disposed in each array. Embodiments of the present disclosure are not limited by the wavelength of the electromagnetic or optical source used in the array. Embodiments of the present invention are not limited to the circuitry, such as phase modulators, splitters, detectors, controllers, encoders, mixers, and the like. Other additions, subtractions or modifications are obvious in view of the present disclosure and are intended to fall within the scope of the appended claims.

What is claimed is:

1. An adaptive LiDAR comprising:
a transmitter comprising:
an array of N radiators; and
a transmitter control block adapted to control an aperture of the transmitter; and
a receiver comprising:
an array of T receive elements; and
a receiver control block adapted to control a scan rate and resolution of the receiver, wherein N and T are integers greater than one.

2. The adaptive LiDAR of claim 1 wherein the transmitter control block is adapted to control the aperture of the transmitter in accordance with data supplied by a user.

3. The adaptive LiDAR of claim 1 wherein the receiver control block is adapted to control the scan rate and resolution of the receiver in accordance with data supplied by a user.

4. The adaptive LiDAR of claim 1 wherein the receiver control block causes the receiver to discern a target at a first scan rate using a first resolution during a first time interval, and to discern the target at a second scan rate using a second resolution during a second time interval, wherein the second scan rate is lower than the first scan rate, and wherein the second resolution is higher than first resolution.

5. The adaptive LiDAR of claim 2 wherein the transmitter and receiver control blocks are adapted to cause each of M radiators of the transmitter to be associated with each of Q receive elements of the receiver, wherein M is an integer equal to or greater than 1 and less than N, and wherein Q is an integer equal to or greater than 1 and less than T.

6. The adaptive LiDAR of claim 5 further comprising:
a first cylindrical lens positioned away from the array of radiator.

7. The adaptive LiDAR of claim 6 wherein the transmitter control block is adapted to cause a beam focused by the lens to move along a direction substantially perpendicular to a central axis of the lens by activating radiators disposed along different rows of the array of radiators.

8. The adaptive LiDAR of claim 6 further comprising:
a second cylindrical lens positioned away from the array of receive elements.

9. The adaptive LiDAR of claim 5 further comprising a plurality of tunable amplitude modulators adapted to generate N optical signals from an incoming optical signal, wherein each tunable amplitude modulator comprises:
a first signal splitter adapted to split a received optical signal into first and second optical signals;
a phase modulator adapted to modulate a phase of the first signal in accordance with a phase control signal to generate a first phase modulated signal;
a directional coupler adapted to combine the second optical signal with the first phase modulated signal to generate a first output signal and a first intermediate optical signal;
a second splitter adapted to split the first intermediate optical signal into a second output signal and a second intermediate optical signal;
a photodetector adapted to convert the second intermediate optical signal to an electrical signal; and
a controller configured to generate the phased control signal using the electrical signal.

10. The adaptive LiDAR of claim 9 wherein the controller is further configured to generate the phase control signal via a control signal generated internally by the adaptive LiDAR.

11. The adaptive LiDAR of claim 9 wherein the controller is further configured to generate the phase control signal via a control signal supplied by a user.

12. The adaptive LiDAR of claim 9 wherein relative powers of the first and second optical signal may be varied, and wherein relative powers of the second output signal and the second intermediate optical signal may be varied.

13. The adaptive LiDAR of claim 9 wherein the power of the second output signal is substantially 99 times the power of the second intermediate optical signal.

14. The adaptive LiDAR of claim 9 further comprising a plurality of phase and amplitude modulation blocks each comprising:
a first phase and amplitude modulator adapted to modulate a phase and/or an amplitude of a first one of the N output signals of the plurality of tunable amplitude modulators in accordance with a first control signal to generate a first modulated signal;
a second phase and amplitude modulator adapted to modulate a phase and/or an amplitude of a second one of the N output signals of the plurality of tunable amplitude modulators in accordance with a second control signal to generate a second modulated signal;
a third signal splitter adapted to split the first modulated signal into a first output signal and a first and second intermediate signals;
a fourth signal splitter adapted to split the second modulated signal into a second output signal and a third and fourth intermediate signals;
a phase detector adapted to detect a difference between phases of the first and third intermediate signals;
a first amplitude detector adapted to detect an amplitude of the second intermediate;
a second amplitude detector adapted to detect an amplitude of the fourth intermediate signal; and
a controller adapted to generate the first and second control signals in accordance with the detected difference between phases of the first and third intermediate signals, and the detected amplitudes of the second and fourth intermediate signals.

15. The adaptive LiDAR of claim 14 wherein the plurality of phase and amplitude modulation blocks generate N optical signals each received by a different one of the array of N radiators.

16. The adaptive LiDAR of claim 5 further comprising:
(N−1) optical switching layers adapted to generate N optical signals each received by a different one of the array of N radiators, wherein a j^{th} optical switching layer includes 2^{j} optical switches, wherein j is in index ranging from 1 to (N−1), wherein each optical switch is adapted to split a received optical signal into a pair of optical signals.

17. The adaptive LiDAR of claim 16 wherein the N optical signals generated by the (N−1) optical switching layers is delivered as N reference signals to the receiver.

18. The adaptive LiDAR of claim 16 wherein a speed of a switch disposed in a first layer of the (N−1) optical switching layers is slower than a speed of a switch disposed in layer (N−1) of the (N−1) optical switching layers.

19. The adaptive LiDAR of claim 1 wherein each receive element comprises a gating coupler and a photodiode.

20. The adaptive LiDAR of claim 1 further comprising a first laser source.

21. The adaptive LiDAR of claim 1 further comprising:
a plurality of semiconductor optical amplifiers each adapted to amplify a laser beam generated by the first laser source and deliver the amplified laser beam to a different one of the plurality of tunable amplitude modulators.

22. The adaptive LiDAR of claim 21 further comprising a path/phase mismatch correction block adapted to cause phases of the beams received from the plurality of phase and amplitude modulators to have a same value.

23. The adaptive LiDAR of claim 20 further comprising:
a second laser source having a wavelength that is different from a wavelength of the first laser source;
a first plurality of semiconductor optical amplifiers each adapted to amplify a laser beam generated by the first laser source and deliver the amplified laser beam to a different one of a first subset of the plurality of tunable amplitude modulators; and
a second plurality of semiconductor optical amplifiers each adapted to amplify a laser beam generated by the second laser source and deliver the amplified laser beam to a different one of a second subset of the plurality of tunable amplitude modulators.

24. The adaptive LiDAR of claim 1 wherein the transmitter control block is adapted to cause formation of an optical beam that is steered in accordance with phases of a plurality of optical signals received by the plurality of radiators.

25. The adaptive LiDAR of claim 24 wherein the receive control block is further adapted to change a direction of the receive elements.

26. The adaptive LiDAR of claim 1 further comprising:
a first cylindrical lens positioned away from the array of radiators; and
a second cylindrical lens positioned away from the array of receive elements.

27. The adaptive LiDAR of claim 26 further comprising:
a first laser source; and
a second laser source having a different wavelength than the first laser source.

28. The adaptive LiDAR of claim 27 further comprising:
a plurality of semiconductor optical amplifiers each adapted to amplify a laser beam generated by the first laser source to generate an amplified laser beam;
a path/phase mismatch correction block adapted to cause phases of the plurality of amplified laser beams to have a same value; and
an optical combiner adapted to combine the plurality of amplified laser beams and deliver the combined beam to the plurality of radiators.

29. The adaptive LiDAR of claim 28 further comprising:
a first plurality of semiconductor optical amplifiers each adapted to amplify a laser beam generated by the first laser source to generate a first plurality of amplified beams;
a first plurality of optical switching layers receiving the first plurality of amplified beams to generate first a plurality of optical signals;
a second plurality of semiconductor optical amplifiers each adapted to amplify a laser beam generated by the second laser source to generate a second plurality of amplified beams;
a second plurality of optical switching layers receiving the second plurality of amplified beams to generate a second plurality of optical signals;
a first path/phase mismatch correction block adapted to shift phases of the first plurality of optical signals so that the first plurality of phase shifted optical signals have a same phase, wherein the first path/phase mismatch correction block delivers the first plurality of phase shifted optical signals to a first subset of the N radiators; and
a second path/phase mismatch correction block adapted to shift phases of the second plurality of optical signals so that the second plurality of phase shifted optical signals have the same phase, wherein the second path/phase mismatch correction block delivers the second plurality of phase shifted optical signals to a second subset of the N radiators.

30. The adaptive LiDAR of claim 1 wherein each of the arrays of radiators and receive elements is a two-dimensional array.

31. The adaptive LiDAR of claim 1 further comprising:
a first array of N micro-lenses positioned over the N radiators, wherein each of the N micro-lenses of the first array is associated with a different one of the N radiators; and
a second array of T micro-lenses positioned over the T receive elements, wherein each of the T micro-lenses of the second array is associated with a different one of the T receive elements.

32. The adaptive LiDAR of claim 1 further comprising:
a first array of P micro-lenses positioned over the N radiators, wherein N is an integer multiple of P, and wherein each of the P micro-lenses of the first array is associated with and receives light from N/P radiators; and
a second array of S micro-lenses positioned over the T receive elements, wherein T is an integer multiple of S, and wherein each of the S micro-lenses of the second array is associated with and delivers light to T/S receive elements.

33. The adaptive LiDAR of claim 31 wherein the transmitter and receiver control block cause a spot size illuminated by transmitter to be greater than a maximum resolution of the receiver.

34. The adaptive LiDAR of claim 32 wherein the transmitter and receiver control blocks cause a spot size illuminated by transmitter to be greater than a maximum resolution of the receiver.

35. The adaptive LiDAR of claim 31 wherein the transmitter and receiver control blocks are adapted to cause each of M radiators of the transmitter to be associated with each of Q receive elements of the receiver, wherein M is an integer equal to or greater than 1 and less than N, and wherein Q is an integer equal to or greater than 1 and less than T.

36. The adaptive LiDAR of claim 32 wherein the transmitter and receiver control blocks are adapted to cause each of M radiators of the transmitter to be associated with each of Q receive elements of the receiver, wherein M is an integer equal to or greater than 1 and less than N, and wherein Q is an integer equal to or greater than 1 and less than T.

37. An adaptive LiDAR comprising:
a transmitter comprising an array of N radiators;
a receiver comprising an array of T receive elements;
an encoder adapted to generate a first and second encoding signals;
a first modulator adapted to modulate a first portion of a laser beam using the first encoding signal, thereby to generate a reference optical signal;
a second modulator adapted to modulate a second portion of the laser beam using the second encoding signal, thereby to generate an optical signal applied to the transmitter, wherein the transmitter illuminates a moving target using the optical signal, wherein the receiver receives an optical signal reflected off the illuminated moving target;
a signal combiner adapted to combine the reference optical signal with the received optical signal to generate a combined signal, said signal combiner further adapted to convert the combined signal to an electrical signal; and
a first controller adapted to vary the first and second encoding signals in accordance with the electrical signal.

38. The adaptive LiDAR of claim 37 further comprising:
an amplifier adapted to amplify the electrical signal; and
a downconverter adapted to downconvert a frequency of the amplified signal.

39. The adaptive LiDAR of claim 38 further comprising:
a filter adapted to filter noise components of the downconverted signal; and
a digital-to-analog converter adapted to convert an output of the downconverter to a digital signal and supply the digital signal to the first controller, wherein the first controller is adapted to vary the first and second encoding signals in accordance with the digital signal.

40. The adaptive LiDAR of claim 39 further comprising a second controller adapted to vary a gain of the amplifier.

41. The adaptive LiDAR of claim 40 wherein the second controller is adapted to vary a downconversion frequency of the downconverter.

42. The adaptive LiDAR of claim 41 wherein the second controller is adapted to change a frequency band of the filter.

43. The adaptive LiDAR of claim 37 wherein the first controller is adapted to cause frequencies of the reference optical signal and the received optical signal to ramp at a first rate during a first time interval, and at a second rate during a second time interval.

44. The adaptive LiDAR of claim 41 wherein the first controller is adapted to cause frequencies of the reference optical signal and the received optical signal to ramp at a first rate during a first time interval, and further to cause amplitudes of the reference optical signal and the received optical signal to ramp at a second rate during the first time interval.

45. The adaptive LiDAR of claim 44 wherein the first controller is adapted to cause frequencies of the reference optical signal and the received optical signal to ramp at a third rate during a second time interval, and further to cause amplitudes of the reference optical signal and the received optical signal to ramp at a fourth rate during the second time interval.

46. A method of determining a distance and a speed of a moving target using an adaptive LiDAR, the method comprising:
illuminating the target by a transmitter of the adaptive LiDAR, wherein the transmitter comprises:
an array of N radiators; and
a transmitter control block adapted to control an aperture of the transmitter;
receiving an optical signal reflected off the illuminated target, wherein the received optical signal is received by a receiver of the adaptive LiDAR, wherein the receiver comprises:
an array of T receive elements; and
a receiver control block adapted to control a scan rate and resolution of the receiver, wherein M and T are integers greater than one; and
determining a distance and the speed of the moving target in accordance with the received optical signal.

47. The method of claim 46 further comprising:
acquiring an image of the target by a CMOS/CCD camera.

48. The method of claim 46 further comprising:
transmitting a radio frequency (RF) RADAR signal to the moving target; and
receiving an RF signal reflected off the moving target.

49. The method of claim 46 further comprising:
training a machine learning system to operate the adaptive LiDAR.

50. The method of claim 46 further comprising:
positioning a first cylindrical lens away from the array of radiators.

51. The method of claim 46 further comprising:
generating N optical signals via (N−1) optical switching layers, each optical signal received by a different one of the array of N radiators, wherein a j^{th} optical switching layer includes 2j optical switches, wherein j is in index ranging from 1 to (N−1), wherein each optical switch is adapted to split a received optical signal into a pair of optical signals, wherein a speed of a switch disposed in a first layer of the (N−1) optical switching layers is slower than a speed of a switch disposed in layer (N−1) of the (N−1) optical switching layers.

52. The method of claim 46 further comprising:
amplifying a laser beam by a plurality of semiconductor optical amplifiers;
delivering the amplified laser beams to a plurality of tunable amplitude modulators; and
causing phases of the laser beams received from the plurality of phase and amplitude modulators to have a same value.

53. The method of claim 46 wherein the adaptive LiDAR further comprises:
a first array of N micro-lenses positioned over the N radiators, wherein each of the N micro-lenses of the first array is associated with a different one of the N radiators; and
a second array of T micro-lenses positioned over the T receive elements, wherein each of the T micro-lenses of the second array is associated with a different one of the T receive elements.

54. A method of determining a distance and a speed of a moving target using an adaptive LiDAR, the method comprising:
generating first and second encoding signals;
modulating a first portion of a laser beam using the first encoding signal, thereby to generate a reference optical signal;
modulating a second portion of the laser beam using the second encoding signal, thereby to generate a transmit optical signal;
illuminating the target by a transmitter of the adaptive LiDAR using the transmit optical signal, wherein the transmitter comprises an array of N radiators;
receiving an optical signal reflected off the illuminated target, wherein the received optical signal is received by a receiver of the adaptive LiDAR, wherein the receiver comprises an array of T receive elements;
combining the reference optical signal with the received optical signal to generate a combined signal;
converting the combined signal to an electrical signal; and
varying the first and second encoding signals in accordance with the electrical signal, wherein N and T are integers greater than one.

55. A machine learning system comprising:
a computing system;
a trained neural network; and
an adaptive LiDAR comprising:
a transmitter comprising:
an array of N radiators; and
a transmitter control block adapted to control an aperture of the transmitter; and
a receiver comprising:
an array of T receive elements; and
a receiver control block adapted to control a scan rate and resolution of the receiver, wherein N and T are integers greater than one.

56. A material detection system comprising:
a computing system;
a trained neural network; and
an adaptive LiDAR comprising:
a transmitter comprising:
an array of N radiators; and
a transmitter control block adapted to control an aperture of the transmitter; and
a receiver comprising:
an array of T receive elements; and
a receiver control block adapted to control a scan rate and resolution of the receiver, wherein N and T are integers greater than one.
